(19) United States
(12) Patent Application Publication
(10) Pub. No.: US 2026/0004443 A1
(43) Pub. Date: Jan. 1, 2026

(54) SYSTEMS, METHODS, AND MEDIA FOR CONCURRENT DEPTH AND MOTION ESTIMATION USING INDIRECT TIME OF FLIGHT IMAGING

(71) Applicant: Wisconsin Alumni Research Foundation, Madison, WI (US)

(72) Inventors: Mohit Gupta, Madison, WI (US); Jongho Lee, Madison, WI (US)

(73) Assignee: Wisconsin Alumni Research Foundation, Madison, WI (US)

(21) Appl. No.: 18/755,293

(22) Filed: Jun. 26, 2024

(51) Int. Cl. G06T 7/579; G01B 11/22; G01S 17/894; G06T 5/50; G06T 5/70; G06T 7/246; G06T 7/521

(52) U.S. Cl. CPC G06T 7/579; G01B 11/22; G01S 17/894; G06T 5/50; G06T 5/70; G06T 7/248; G06T 7/251; G06T 7/521; G06T 2207/10028

(57) ABSTRACT

In accordance with some embodiments, systems, methods and media for concurrent depth and motion estimation using indirect time-of-flight imaging are provided. In some embodiments, the system comprises: a processor configured to: receive a first set of correlation images generated by an I-ToF camera; receive a second set of correlation images generated; generate a first and second blurred intensity image using the first and second set of correlation images, respectively; determine estimated lateral motion in the scene based on a distribution of intensity values in the first and second blurred images; and determine a first and second depth map for the scene based on the first and second sets of correlation images, respectively, and based on the estimated lateral motion in the scene.

### STATEMENT REGARDING FEDERALLY SPONSORED RESEARCH

This invention was made with government support under 2003129 and CNS2107060 awarded by the National Science Foundation. The government has certain rights in the invention.

### CROSS-REFERENCE TO RELATED APPLICATIONS

N/A

### BACKGROUND

Although time-of-flight (ToF) cameras are becoming the sensor-of-choice for numerous 3D imaging applications in robotics, augmented reality (AR) and human-computer interfaces (HCI), they do not explicitly consider scene or camera motion. Consequently, current ToF cameras do not provide 3D motion information, and the estimated depth and intensity often suffers from significant motion artifacts in dynamic scenes.

In recent years, time-of-flight (ToF) cameras have become increasingly common for various 3D imaging applications, such as 3D mapping, human-machine interaction, augmented reality, and robot navigation. ToF cameras typically have compact form-factors and low computational complexity, which has resulted in the emergence of several commodity ToF cameras. However, ToF cameras generally do not explicitly consider scene or camera motion. Consequently, conventional ToF cameras are generally not capable of providing 3D motion information, and the estimated depth and/or intensity information often suffers from significant motion artifacts in dynamic scenes.

Accordingly, systems, methods, and media described herein for concurrent depth and motion estimation using indirect time-of-flight imaging are desirable.

### SUMMARY

In accordance with some embodiments of the disclosed subject matter, a system for estimating depths of a dynamic scene is provided, the system comprising: a light source; an image sensor comprising a plurality of pixels; a signal generator configured to output at least: a first signal corresponding to a modulation function; and one or more processors configured to: cause the light source to emit modulated light toward the scene, with modulation based on the first signal; cause the image sensor to generate, during a first period of time, a first set of correlation images comprising a first plurality of correlation images, wherein each correlation image of the first plurality of correlation images comprises a plurality of pixel values, and each pixel value of the plurality of pixel values is based on a correlation between modulated light received from a portion of the scene at that pixel and a demodulation function of a plurality of demodulation functions; generate a first intensity image based on the first set of correlation images, wherein the first intensity image comprises a first plurality of intensity values; cause the image sensor to generate, during a second period of time, a second set of correlation images comprising a second plurality of correlation images; generate a second intensity image based on the second set of correlation images, wherein the second intensity image comprises a second plurality of intensity values; calculate a first model of the first intensity image based on the first plurality of intensity values; calculate a second model of the second intensity image based on the second plurality of intensity values; determine estimated lateral motion in the scene between the first period of time and the second period of time based on the first model and the second model; and determine a set of depth estimates for the scene based on the first plurality of correlation images and the estimated lateral motion in the scene, wherein the set of depth estimates comprises, for each of the plurality of pixels, a depth estimate for a corresponding portion of the scene during the first period of time.

In some embodiments, the one or more processors are further configured to: generate a refined intensity image based on the first plurality of correlation images and the estimated lateral motion in the scene, wherein a signal-to-noise ratio of the refined intensity image is higher than a signal-to-noise ratio of the intensity image.

In some embodiments, the one or more processors are further configured to: determine a second set of depth estimates for the scene based on the second plurality of correlation images and the estimated lateral motion in the scene, wherein the second set of depth estimates comprises, for each of the plurality of pixels, a depth estimate for a corresponding portion of the scene during the second period of time; and determine an estimate of axial motion for at least a portion of the scene based on the first set of depth estimates, the second set of depth estimates, and the estimated lateral motion in the scene.

In some embodiments, the one or more processors are further configured to: identify, for each of the plurality of pixels represented in the first set of depth estimates, a corresponding pixel represented in the second set of depth estimates using the estimated lateral motion for the pixel represented in the first set of depth estimates; and estimate, for each of the plurality of pixels represented in the first set of depth estimates, the axial motion for a portion of the scene corresponding to that pixel based on a difference between the depth estimate for the pixel represented in the first set of depth estimates and the depth estimate for the corresponding pixel represented in the second set of depth estimates.

In some embodiments, the one or more processors are further configured to: cause the light source to emit modulated light toward the scene with modulation based on a second signal, wherein the first signal is a periodic signal with a first fundamental frequency f₁, and the second signal is a periodic signal with a second fundamental frequency f₂ that is different than the first fundamental frequency, and wherein each correlation image of the second plurality of correlation images comprises a second plurality of pixel values, and each pixel value of the second plurality of pixel values is based on a correlation between modulated light of the second fundamental frequency received from a portion of the scene at that pixel and a demodulation function of a second plurality of demodulation functions.

In some embodiments, a maximum unambiguous measurable depth range measurable using a modulation function with the first fundamental frequency f₁ is Zₘₐₓ(f₁), and a maximum unambiguous measurable depth range measurable using a modulation function with the second fundamental frequency f₂ is Zₘₐₓ(f₂), such that if the scene has a maximum depth Zₘₐₓ′>Zₘₐₓ(f₁)>Zₘₐₓ(f₂), depth estimates in an initial first set of depth estimates based on the first set of correlation images are ambiguous, and depth estimates in an initial second set of depth estimates based on the first set of correlation images are ambiguous, and wherein the one or more processors are further configured to: decode the set of depth estimates and the second set of depth estimates using the initial first set of depth estimates and the initial second set of depth estimates, such that the set of depth estimates and the second set of depth estimates include unambiguous depth estimates.

In some embodiments, the plurality of demodulation functions comprises a plurality of versions of the modulation function, each having a different phase shift.

In some embodiments, the modulation function is a unipolar sinusoidal modulation function.

In some embodiments, the first model comprises a spatial gradient of the first intensity image, the second model comprises a spatial gradient of the second intensity image, and wherein the one or more processors are further configured to: determine the estimated lateral motion in the scene based on correlations between the first model and the second model.

In some embodiments, the one or more processors are further configured to: generate a first set of burst correlation images based on a plurality of sets of correlation images generated using the plurality of demodulation functions, a plurality of sets of correlation images includes the first set of correlation images, wherein pixel values of a first burst correlation image in the first set of burst correlation images are based pixel values of correlation images in the plurality of sets of correlation images generated using the same demodulation function and correlations between the correlation images in the plurality of sets of correlation images generated using the same demodulation function; generate a second set of burst correlation images based on at least the second set of correlation images; generate the first intensity image using the first set of burst correlation images; and generate the second intensity image using the second set of burst correlation images.

In some embodiments, the first signal is a periodic signal with a first fundamental frequency f₁, and the plurality of sets of correlation images were generated based on the first signal, and wherein the second set of burst correlation images are based on a second plurality of sets generated based on a second signal that is a periodic signal with a second fundamental frequency f₂≠f₁.

In some embodiments, the one or more processors are further configured to: identify a set of corresponding pixels in the first set of correlation images based on the estimated lateral motion; and determine a depth estimate for a portion of the scene corresponding to the set of corresponding pixels based on pixel values of the set of corresponding pixels.

In some embodiments, the one or more processors are further configured to: generate the first intensity image based on the first set of correlation images according to the following expression:

$${I}_{1} ( p ) = \frac{1}{N} \sqrt{{( {\sum }_{n = 1}^{N} {C}_{1 , n} ( p ) cos {ψ}_{n} )}^{2} + {( {\sum }_{n = 1}^{N} {C}_{1 , n} ( p ) sin {ψ}_{n} )}^{2}}$$

where I₁ is the first intensity image, I₁(p) is the intensity value of a pixel p in the first intensity image, C₁ is the first set of correlation images, C_{1,n}(p) is the value for pixel p in the n^{th} correlation image in C₁, N is a number of correlation images in C₁, and ψₙ is a phase shift of the demodulation function used to generate the n^{th} correlation image, such that the first intensity image is blurred based on motion in the scene; and determine the set of depth estimates for the scene according to the following expression:

$${Z}_{1} ( p ) = \frac{c}{4 π {f}_{1}} {tan}^{- 1} ( \frac{{\sum }_{n = 1}^{N} {C}_{1 , n} ( {p}^{′} ) sin {ψ}_{n}}{{\sum }_{n = 1}^{N} {C}_{1 , n} ( {p}^{′} ) cos {ψ}_{n}} )$$

where Z₁ is the set of depth estimates for the scene based on C₁, Z₁(p) is the depth estimate of pixel p in the first intensity image, C_{1,n}(p′) is the value for a pixel p′ in the n^{th} correlation image in C₁ in the set of corresponding pixels that includes C_{1,1}(p), and f₁ is a frequency of the first signal.

In accordance with some embodiments of the disclosed subject matter, a method for estimating depths of a dynamic scene is provided, the method comprising: causing a light source to emit modulated light toward the scene, with modulation based on a first signal from a signal generator configured to output at least the first signal corresponding to a modulation function; causing an image sensor to generate, during a first period of time, a first set of correlation images comprising a first plurality of correlation images, wherein the image sensor comprises a plurality of pixels, and wherein each correlation image of the first plurality of correlation images comprises a plurality of pixel values, and each pixel value of the plurality of pixel values is based on a correlation between modulated light received from a portion of the scene at that pixel and a demodulation function of a plurality of demodulation functions; generating a first intensity image based on the first set of correlation images, wherein the first intensity image comprises a first plurality of intensity values; causing the image sensor to generate, during a second period of time, a second set of correlation images comprising a second plurality of correlation images; generating a second intensity image based on the second set of correlation images, wherein the second intensity image comprises a second plurality of intensity values; calculating a first model of the first intensity image based on the first plurality of intensity values; calculating a second model of the second intensity image based on the second plurality of intensity values; determining estimated lateral motion in the scene between the first period of time and the second period of time based on the first model and the second model; and determining a set of depth estimates for the scene based on the first plurality of correlation images and the estimated lateral motion in the scene, wherein the set of depth estimates comprises, for each of the plurality of pixels, a depth estimate for a corresponding portion of the scene during the first period of time.

In accordance with some embodiments of the disclosed subject matter, a system for estimating depths of a dynamic scene using indirect time-of-flight (I-ToF) is provided, the system comprising: one or more processors configured to: receive a first set of correlation images generated by an I-ToF camera during a first period of time; receive a second set of correlation images generated by the I-ToF camera during a second period of time; generate a first blurred intensity image using the first set of correlation images; generate a second blurred intensity image using the second set of correlation images; determine estimated lateral motion in the scene between the first period of time and the second period of time based on a distribution of intensity values in the first blurred image and a distribution of intensity values in the second blurred image; determine a first depth map for the scene based on the first set of correlation images and the estimated lateral motion in the scene; and determine a second depth map for the scene based on the second set of correlation images and the estimated lateral motion in the scene.

In some embodiments, the system further comprises the I-ToF camera, wherein the I-ToF camera comprises a first processor of the one or more processors.

In some embodiments, the one or more processors are further configured to: generate a first refined intensity image using the first set of correlation images and the estimated lateral motion in the scene; and generate a second refined intensity image using the second set of correlation images and the estimated lateral motion in the scene.

In some embodiments, the one or more processors are further configured to: determine estimated axial motion in the scene between the first period of time and the second period of time based on differences between depth values in the first depth map and depth values in the second depth map identified using the estimated lateral motion in the scene.

In some embodiments, the one or more processors are further configured to: calculate a first spatial gradient of the first blurred intensity image; calculate a second spatial gradient of the second blurred intensity image; and identify correlations between the first spatial gradient and the second spatial gradient using an optical flow algorithm; and determine the estimated lateral motion in the scene between the first period of time and the second period of time using the correlations.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Various objects, features, and advantages of the disclosed subject matter can be more fully appreciated with reference to the following detailed description of the disclosed subject matter when considered in connection with the following drawings, in which like reference numerals identify like elements.

FIG. 1 shows an example of a system for indirect time-of-flight imaging in accordance with some embodiments of the disclosed subject matter.

FIG. 2 shows an example of depth and intensity estimates of a dynamic scene generated using conventional indirect time-of-flight techniques and using indirect time-of-flight techniques implemented in accordance with some embodiments of the disclosed subject matter.

FIG. 3 shows an example of a static scene and a dynamic scene, with correlation images generated from the two scenes using conventional indirect time-of-flight techniques, as well as depth and intensity estimates generated using conventional indirect time-of-flight techniques, and a comparison of the quality of depth estimates generated using conventional indirect time-of-flight techniques with short and long integration times to a depth estimates generated using indirect time-of-flight techniques implemented in accordance with some embodiments of the disclosed subject matter.

FIG. 4A shows an example of two sets of correlation images generated using indirect time-of-flight techniques with a position of a dynamic scene point p reflected in each correlation image, and representations of spatial gradients generated from each set of correlation images in accordance with some embodiments of the disclosed subject matter.

FIG. 4B shows an example of a dynamic scene, and motion estimates generated from correlation images generated using conventional indirect time-of-flight techniques and motion estimates generated from spatial gradients based on sets of correlation images in accordance with some embodiments of the disclosed subject matter.

FIG. 5 shows an example of a process for concurrently estimating motion, depth, and/or intensity of a scene using an indirect time-of-flight imaging system in accordance with some embodiments of the disclosed subject matter.

FIG. 6 shows an example of a process for generating a set of correlation images using an indirect time-of-flight imaging system in accordance with some embodiments of the disclosed subject matter.

FIG. 7 shows an example of a process for generating and using motion, depth, and/or intensity estimates for a scene from a stream of data captured sequentially from a in accordance with some embodiments of the disclosed subject matter.

FIG. 8 shows an example of standard deviations of velocity measurements under various conditions using Doppler time-of-flight and indirect time-of-flight techniques implemented in accordance with some embodiments of the disclosed subject matter.

FIG. 9 shows an example of axial motion estimates generated under various conditions using Doppler time-of-flight techniques and indirect time-of-flight techniques implemented in accordance with some embodiments of the disclosed subject matter.

FIG. 10 shows an example of a static scene, with depth estimates generated using various indirect time-of-flight techniques, including single-frequency coding, multi-frequency coding, burst denoising from correlation images, and multi-frequency coding and burst imaging techniques.

FIG. 11 shows an example of motion estimates generated from spatial gradients based on sets of correlation images of various dynamic scenes in accordance with some embodiments of the disclosed subject matter.

FIG. 12 shows examples of intensity and depth estimates for two scenes generated using conventional indirect time-of-flight techniques with short and long integration times to a depth and intensity estimates generated using indirect time-of-flight techniques implemented in accordance with some embodiments of the disclosed subject matter.

FIG. 13 shows examples of intensity and motion estimates for various indoor and outdoor scenes generated using indirect time-of-flight techniques implemented in accordance with some embodiments of the disclosed subject matter.

### DETAILED DESCRIPTION

In accordance with various embodiments, mechanisms (which can, for example, include systems, methods, and media) for concurrent depth and motion estimation using indirect time of flight imaging are provided.

In accordance with some embodiments of the disclosed subject matter, mechanisms described herein can facilitate ToF imaging suitable for dynamic scenes, for example, by simultaneously estimating 3D geometry of a scene, intensity information of the scene, and 3D motion information of the scene using a single indirect ToF (I-ToF) camera. As described below, motion artifact-free depth and intensity information and three-dimensional scene motion can be estimated using optical-flow-like techniques that operate on coded correlation images generated using an I-ToF camera.

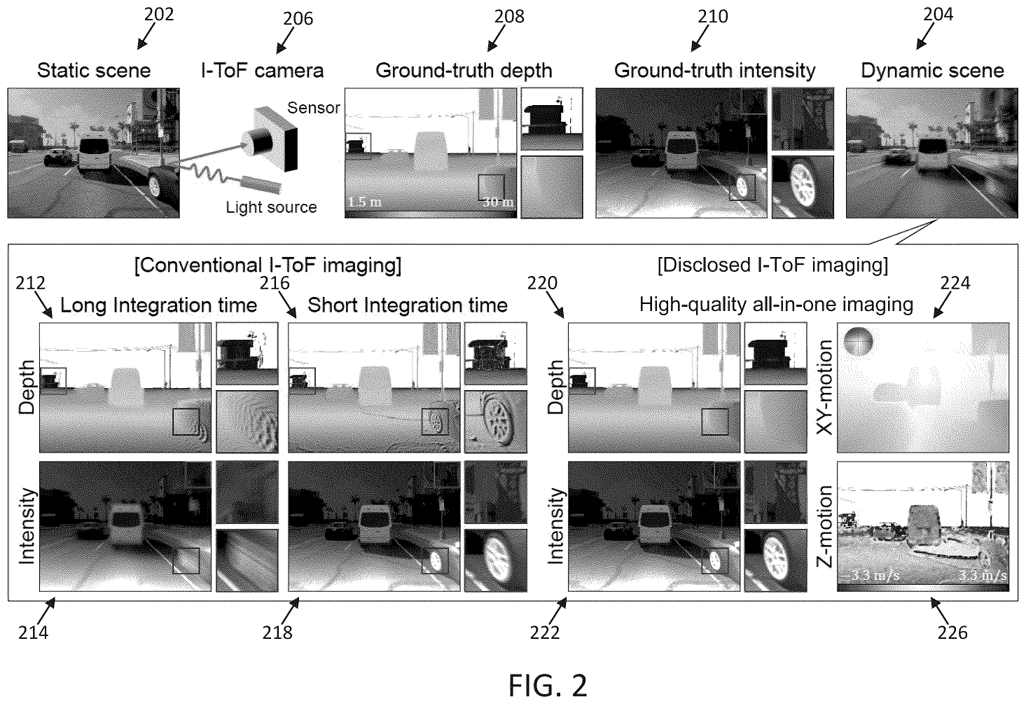

Additionally, in some embodiments, mechanisms described herein can include multi-frequency I-ToF techniques and/or burst imaging techniques that can facilitate high-quality all-in-one imaging (e.g., generating 3D geometry, intensity, and 3D motion information), even in challenging low signal-to-noise ratio scenarios. Results of simulated and real experiments conducted across a wide range of motion and imaging scenarios, including indoor and outdoor dynamic scenes, are described below (e.g., in connection with FIGS. 2, 3, 4B, and 9-13), and demonstrate the effectiveness of mechanisms described herein.

Understanding and/or interacting with a dynamic 3D world can be a complex task, demanding an integrated grasp of geometry, intensity, and motion. While 3D geometry and intensity can be used to understand the identities and locations of scene objects, 3D motion provides insight into the actions and/or behavior of the scene objects. For example, for an autonomous vehicle, it is essential not only to detect neighboring vehicles and other objects in the environment, but also to estimate the motion or the for safe navigation. As another example, for a head-mounted camera on an AR headset, being able to track the intricate 3D motion of fingers can facilitate seamless manipulation of virtual objects. As additional examples, more broadly, the ability to measure dense 3D scene motion, along with depths and intensities in the scene has many applications in robotics manipulation and/or navigation, AR, computer vision, and HCI.

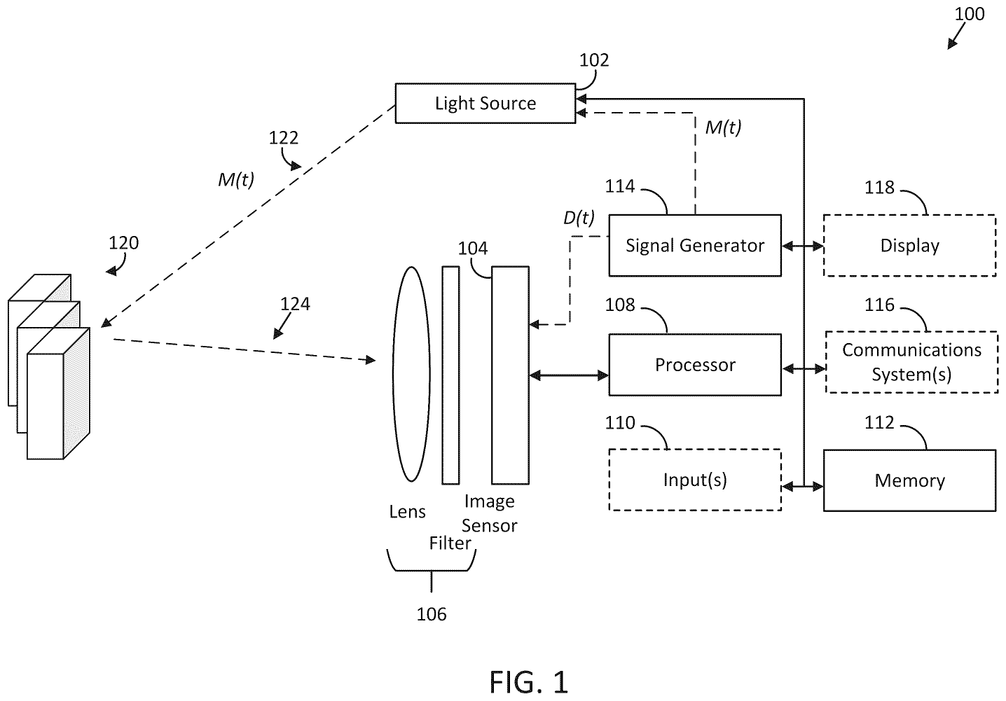

In general, I-ToF cameras have become a popular sensing technology used to perceive the 3D world. Such cameras can emit temporally coded light onto the scene and measure its depth and intensity from the reflected light (e.g., as described below in connection with FIGS. 1 and 2). Due to the relatively low cost, relatively low computational complexity, and relatively compact form factors, I-ToF cameras have rapidly been adopted in many commercial 3D applications, including autonomous vehicles, cell phones, HCI, and/or AR/VR devices.

Optical flow is a term that is sometimes used to refer to a classical technique for measuring dense 2D XY-motion across conventional images, and scene flow is a term that is sometimes used to refer to techniques that generate a dense 3D motion field (e.g., 2D XY-motion+1D Z-motion) for 3D scene points. Conventional scene flow approaches typically use RGB-D cameras, where color information is used for XY-motion estimation and depth information is used for Z-motion estimation. However, these approaches typically assume that accurate depth information is available from the depth camera, which is not always true, such as in the case of dynamic scenes (and/or in other challenging scenarios). For example, the depth information generated by an RGB-D camera may be generated using I-ToF techniques, and as described below, depth information generated using conventional I-ToF techniques can include motion artifacts. Additionally, as described below, conventional optical flow techniques generally cannot be used to improve depth accuracy of conventional I-ToF techniques for dynamic scenes, as raw correlation images are spatio-temporally coded, and thus do not preserve brightness constancy, causing conventional optical flow techniques to inaccurately estimate motion between correlation images in a set of correlation images. In some embodiments, mechanisms described herein can be used to recover accurate depth, intensity, and motion information with a single I-ToF camera for dynamic scenes.

To reduce motion artifacts in I-ToF imaging, some techniques have been proposed that capture two out-of-phase correlation images at the same time and generate brightness-conserving images from their sum. In such techniques, after obtaining the lateral (XY) motion between all temporally neighboring correlation images from the correlation-sum images, a depth map is recovered by warping the correlation images along the XY-motion. However, these techniques cannot be used when out-of-phase images are not available at the same time, and/or when the sum of such images is likely to introduce additional artifacts, which is the case for most commercial I-ToF cameras. In some embodiments, mechanisms described herein can mitigate the number and/or impact of motion artifacts generated by an I-ToF camera for dynamic scenes, which can facilitate recovery of accurate depth, intensity, and motion information without motion artifacts.

A few techniques have been proposed to estimate axial (Z) motion in a scene using I-ToF cameras. For example, techniques have been proposed that attempt to measure the Doppler frequency shift of source light, which is proportional to the object's velocity along the direction of propagation of the light (e.g., radially when a point source is being used). Although theoretically feasible, such techniques approaches have limited scope in most practical conditions, where the Doppler shift is negligibly small as compared to the modulation frequency of the light source, making it challenging to robustly measure the Z-motion. In some embodiments, mechanisms described herein can facilitate robust, real-time (or near real-time) axial motion estimation using an I-ToF camera for dynamic scenes.

Conventional burst imaging techniques attempt to create a high-quality image from a burst of underexposed noisy conventional images (e.g., RGB images) by aligning and merging the images along the pixel motion. Such burst denoising techniques can be used to increase the capture time of a conventional image computationally while mitigating motion blur that would occur with a single longer exposure of a dynamic scene. However, as described below, burst imaging techniques generally cannot be used with conventional I-ToF techniques, as raw correlation images are spatio-temporally coded, and thus do not preserve brightness constancy, causing conventional burst imaging techniques to inaccurately align the different correlation images in a set of correlation images. In some embodiments, mechanisms described herein can adapt burst imaging techniques to increase the SNR of I-ToF correlation images, which can facilitate higher quality depth and intensity estimates, even in challenging scenarios including low scene albedo and strong ambient light.

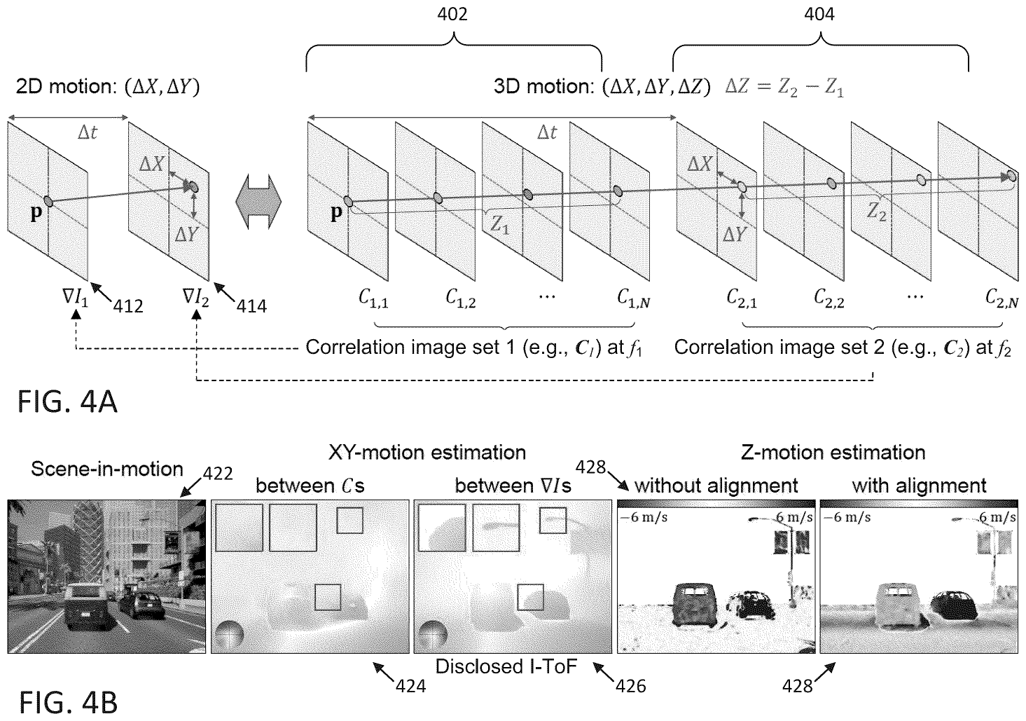

In I-ToF imaging, higher modulation frequency increases depth accuracy but decreases measurable depth range, as described below. Multi-frequency schemes have been proposed to overcome this trade-off by using two different frequencies, for example, using a combination of low and high frequencies to achieve higher depth precision with a longer depth range, or two high frequencies to achieve similar results. Both approaches generally require decoding to recover a correct depth map from two interim depth maps obtained with the two different frequencies. However, the decoding can fail in very low SNR imaging conditions, such as for dynamic scenes, scenarios including low scene albedo, and/or strong ambient light. In some embodiments, mechanisms described herein can facilitate use of multi-frequency coding in challenging scenarios (e.g., by using a multi-frequency scheme in combination with higher SNR correlation image data, such as via alignment of the data from multiple correlation images based on the lateral scene motion, as described below in connection with FIG. 4A, and/or via utilizing adapted burst denoising techniques to generate higher quality correlation images that can facilitate higher quality depth estimation).

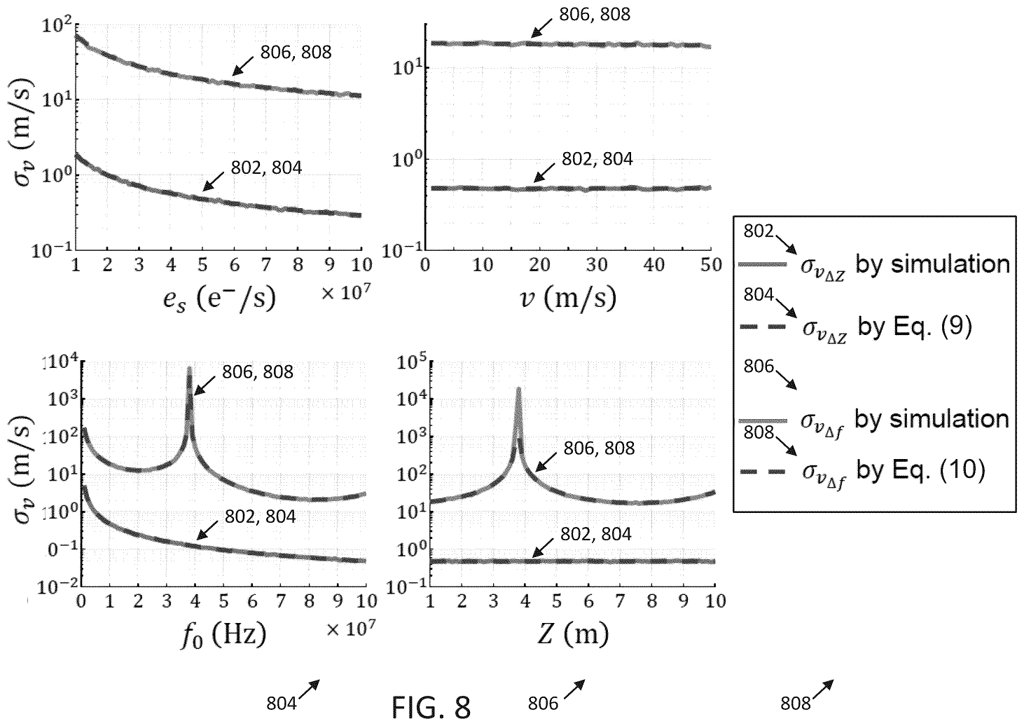

In some embodiments, mechanisms described herein can be used to implement accurate and simultaneous depth, intensity, and motion estimation using a single I-ToF camera (which can be referred to as “all-in-one” imaging). For example, mechanisms described herein can be used with an I-ToF camera to facilitate high-quality 3D geometry, intensity, and 3D motion estimation with a single I-ToF camera via incorporation of motion in the I-ToF image-formation model from first principles, which can address the tradeoff between motion artifacts and low SNR that has long been a limiting factor of I-ToF cameras. As described below in connection with FIGS. 8 to 13, simulations and hardware experiments have been performed that demonstrate that mechanisms described herein can reliably recover 3D geometry and intensity of both indoor and outdoor scenes in challenging imaging scenarios (e.g., strong ambient light, low scene albedo, high-speed non-rigid scene motion), and estimate dense, high-resolution 3D motion (including both lateral and axial motion with respect to the camera). For example, mechanisms described herein can facilitate holistic 3D inference in a computer vision system through integration of geometry, intensity, and motion information.

FIG. 1 shows an example of a system 100 for indirect time-of-flight imaging in accordance with some embodiments of the disclosed subject matter.

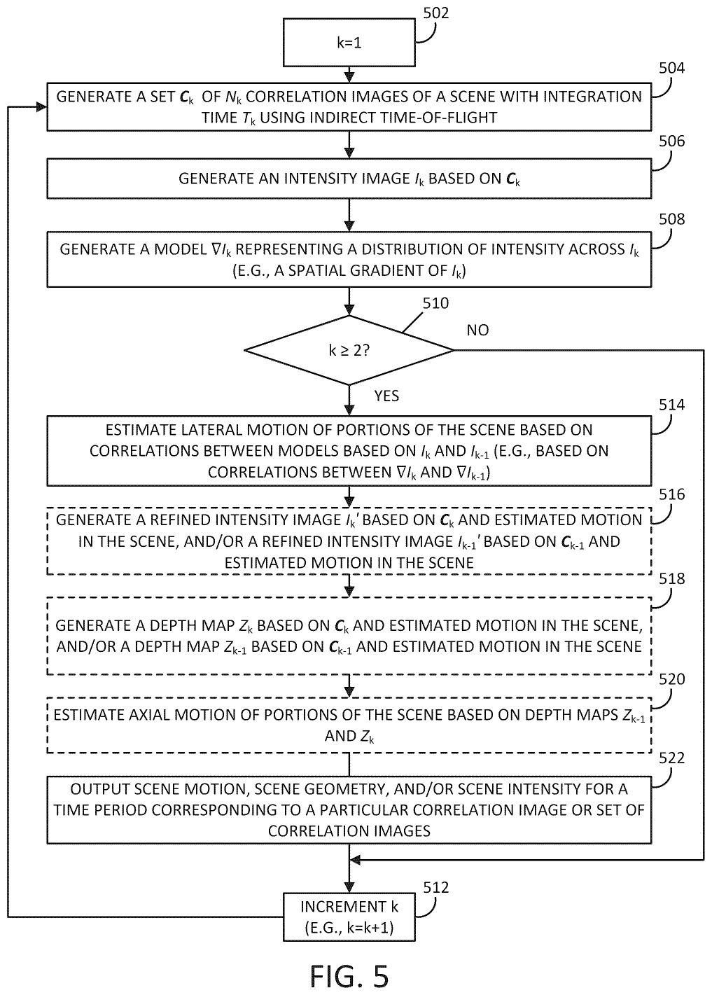

As shown in FIG. 1, system 100 can include a light source 102; an image sensor 104; optics 106 (which can include, for example, a lens, a filter, etc.); a processor 108 for controlling operations of system 100 which can include any suitable hardware processor or combination of processors (e.g., a central processing unit (CPU), a graphics processing unit (GPU), an application specific integrated circuit (ASIC), a field-programmable gate array (FPGA), a digital signal processor (DSP), a microcontroller (μC), an image processor, etc.); an input device 110 (such as a shutter button, a menu button, a microphone, a touchscreen, a motion sensor, etc.) for accepting input from a user and/or from the environment; memory 112; a signal generator 114 for generating one or more modulation and/or demodulation signals; a communication system or systems 116 for allowing communication between processor 108 and other devices, such as a smartphone, a wearable computer, a tablet computer, a laptop computer, a personal computer, a game console, a server, etc., via a communication link; and a display 118 (e.g., a touchscreen, a liquid crystal display, a light emitting diode display, etc.) to present information (e.g., images, user interfaces, graphics, etc.) for consumption by a user. In some embodiments, memory 112 can store pixel values output by image sensor 104, correlation images generated by image sensor 104, an intensity image based on a set of correlation images, a model(s) representing how intensity is distributed across an intensity image, depth values calculated based on output from image sensor 104 and/or a set of correlation images, motion information based on output from image sensor 104 and/or a set of correlation images, etc. Memory 112 can include a storage device (e.g., random access memory (RAM), read-only memory (ROM), electronically-erasable programmable read-only memory (EEPROM), one or more flash drives, one or more hard disks, one or more solid state drives, one or more optical drives, etc.) for storing a computer program for controlling processor 108. In some embodiments, memory 112 can include instructions for causing processor 108 to execute one or more portions of a process(es) associated with the mechanisms described herein, such as processes described below in connection with FIGS. 5 to 7.

In some embodiments, light source 102 can be any suitable light source that can be configured to emit modulated light 122 toward a scene 120 in accordance with a modulation signal (e.g., M(t)) received from signal generator 116. For example, light source 102 can include one or more laser diodes, one or more lasers that are defocused using a concave lens, one or more light emitting diodes, and/or any other suitable light source. In some embodiments, light source 102 can emit light at any suitable wavelength. For example, light source 102 can emit visible light, near-infrared light, infrared light, etc. In a more particular example, light source 102 can be a laser diode that emits light centered around 830 nm that can be modulated using any suitable signal. In a yet more particular example, light source 102 can be an L830P200 laser diode or L850P200 laser diode (available from Thorlabs, Inc., headquartered in Newton, N.J.) that can be modulated with arbitrary waveforms by an external signal of up to 500 MHz bandwidth.

In some embodiments, image sensor 104 can be any suitable image sensor that can receive modulated light 124 reflected by scene 120 and, using a demodulation signal (e.g., D(t)) from signal generator 114, generate signals that are indicative of the time elapsed from when the modulated light 122 was emitted by light source 102 until reflected modulated light 124 reached image sensor 104 after being reflected by scene 120. Any suitable technique or combination of techniques can be used to generate signals based on the demodulation signal received from signal generator 116. For example, the demodulation signal can be an input to a variable gain amplifier associated with each pixel, such that the output of the pixel is based on the value of the demodulation signal when the modulated light was received (e.g., by amplifying the signal produced by the photodiode). As another example, the demodulation signal can be used as an electronic shutter signal that controls an operational state of each pixel. As yet another example, the demodulation signal can be used as an input and/or control signal for a comparator associated with each pixel that compares the signal generated by a photodiode in the pixel to a threshold, and outputs a binary signal based on the comparison. As still another example, the demodulation signal can be used to control an optical shutter. In such an example, the optical shutter can be a global shutter and/or a shutter associated with individual pixels or groups of pixels (e.g., an LCD shutter). Note that in some embodiments, light source 102 and image sensor 104 can be co-located (e.g., using a beam splitter and/or other suitable optics).

In some embodiments, optics 106 can include optics for focusing light received from scene 120, one or more narrow bandpass filters centered around the wavelength of light emitted by light source 102, any other suitable optics, and/or any suitable combination thereof. In some embodiments, a single filter can be used for the entire area of image sensor 104 and/or multiple filters can be used that are each associated with a smaller area of image sensor 104 (e.g., with individual pixels or groups of pixels).

In some embodiments, a depth estimate and/or scene intensity can be based on signals read out from image sensor 104 serially and/or in parallel. For example, if a coding scheme uses three demodulation functions, image sensor 104 can use a single pixel to successively generate a first value based on the first demodulation function at a first time, a second value based on the second demodulation function at a second time that follows the first time, and a third value based on the third demodulation signal at a third time that follows the second time. As another example, image sensor 104 can use multiple sub pixels to simultaneously generate a first value by applying the first demodulation function to a first sub-pixel at a first time, a second value by applying the second demodulation function to a second sub-pixel at the first time, and a third value by applying the third demodulation function to a third sub-pixel at the first time.

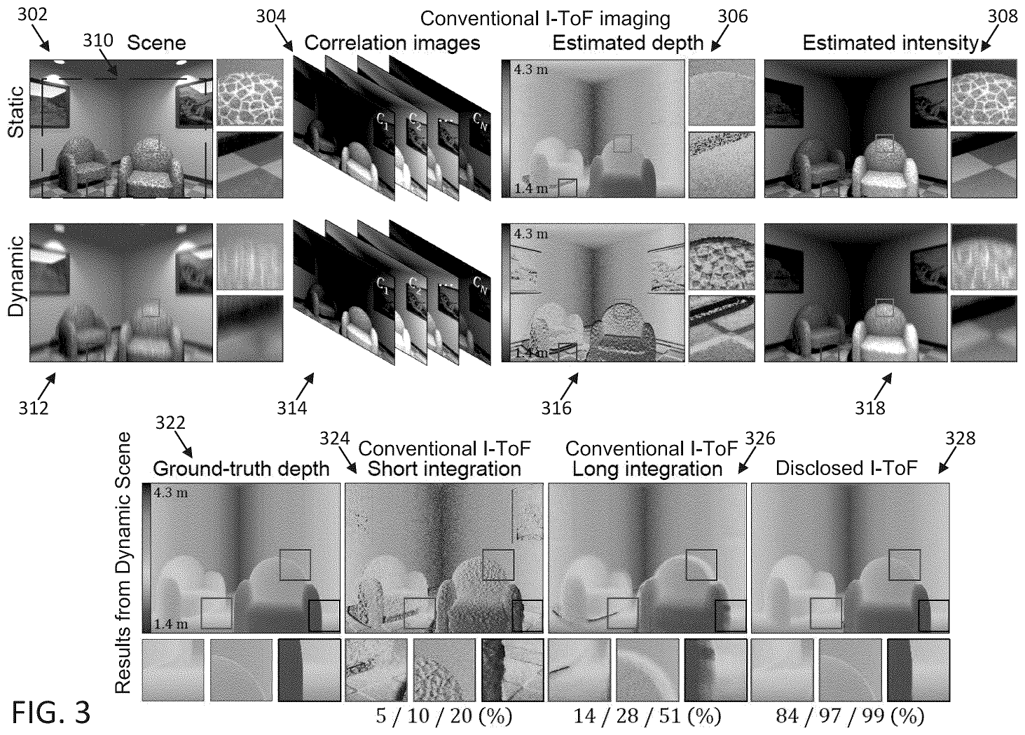

In some embodiments, signal generator 114 can be one or more signal generators that can generate signals to control light source 102 using a modulation signal, and provide demodulation signals for the image sensor. In some embodiments, signal generator 114 can generate multiple different types of signals (e.g., an impulse train and a sinusoid wave), that are synchronized (e.g., using a common clock signal). Although a single signal generator is shown in FIG. 1, any suitable number of signal generators can be used in some embodiments. Additionally, in some embodiments, signal generator 114 can be implemented using any suitable number of specialized analog and/or digital circuits each configured to output a signal that can be used to implement a particular coding scheme. In some embodiments, one or more of the demodulation signals D(t) can be a phase shifted version of the modulation signal M(t), for example as described below in connection with FIG. 3, and in section A1 of Appendix A, which is hereby incorporated by reference herein in its entirety).

In some embodiments, system 100 can communicate with a remote device over a network using communication system(s) 116 and a communication link(s), and/or communication network(s). For example, communication system(s) 116 can communicate via a wired link, a fiber optic link, a Wi-Fi link, a Bluetooth link, a cellular link, an ultrawideband link, etc. As another example, communication system(s) 116 can communicate using: a wired network; a Wi-Fi network, which can include one or more wireless routers, one or more switches, etc.; a peer-to-peer network, such as a Bluetooth network; a cellular network, such as a 3G network, a 4G network, a 5G network, etc., complying with any suitable standard, such as CDMA, GSM, LTE, LTE Advanced, NR, etc. In such an example, the communication network(s) can include a local area network, a wide area network, a public network (e.g., the Internet), a private or semi-private network (e.g., a corporate or university intranet), any other suitable type of network, or any suitable combination of networks.

Additionally or alternatively, in some embodiments, system 100 can be included as part of another device, such as a smartphone, a tablet computer, a laptop computer, an automobile, etc. Parts of system 100 can be shared with a device within which system 100 is integrated. For example, if system 100 is integrated with a smartphone, processor 108 can be a processor of the smartphone and can be used to control operation of system 100.

In some embodiments, system 100 can communicate with any other suitable device, where the other device can be one of a general purpose device such as a computer or a special purpose device such as a client, a server, etc. Any of these general or special purpose devices can include any suitable components such as a hardware processor (which can be a microprocessor, digital signal processor, a controller, etc.), memory, communication interfaces, display controllers, input devices, etc. For example, the other device can be implemented as a digital camera, security camera, outdoor monitoring system, a smartphone, a wearable computer, a tablet computer, a vehicle such as an automobile, a personal data assistant (PDA), a personal computer, a laptop computer, a multimedia terminal, a game console or peripheral for a gaming counsel or any of the above devices, a server, etc.

Note that data received through a communication link and/or any other communication link(s) can be received from any suitable source. In some embodiments, processor 108 can send and receive data through the communication link or any other communication link(s) using, for example, a transmitter, receiver, transmitter/receiver, transceiver, or any other suitable communication device.

In some embodiments, display 118 can be used to present images and/or video generated using image sensor 104 and/or by another device, to present a user interface, to present information (e.g., text, graphics, etc.) about the scene generated using image data captured by image sensor 104, etc. In some embodiments, display 118 can be implemented using any suitable device or combination of devices, and can include one or more inputs, such as a touchscreen. In some embodiments, display 118 and/or inputs 110 can be omitted (e.g., where system 100 is an embedded device that is not configured for direct user interaction).

FIG. 2 shows an example of depth and intensity estimates of a dynamic scene generated using conventional indirect time-of-flight techniques and using indirect time-of-flight techniques implemented in accordance with some embodiments of the disclosed subject matter.

In general, conventional I-ToF imaging techniques can be used to recover accurate 3D geometry and intensity of static scenes (e.g., without significant relative movement of between the camera and objects in the scene). However, for dynamic scenes, depth and intensity estimates generated using conventional I-ToF imaging techniques suffer from motion artifacts. The impact of scene motion on the depth and intensity estimates generated using conventional I-ToF imaging techniques can be mitigated by shortening the integration times, but this results in noisier estimates, as the signal-to-noise ratio (SNR) is lower with lower integration times. In some embodiments, mechanisms described herein can estimate higher quality 3D geometry and intensity (e.g., with improved SNR and/or reduced motion artifacts). Additionally, in some embodiments, mechanisms described herein can also estimate 3D motion in a dynamic scenes using a single I-ToF camera.

For example, FIG. 2 includes a depiction of a static scene 202, a depiction of a dynamic scene 204, and a representation of an I-ToF camera system 206. In general, when imaging static scene 202 with relatively aggregate long integration times for each correlation image (e.g., on the order of one to two seconds, based on data from 1,000 to 2,000 relatively short exposures of 1 to 2 milliseconds (ms)), I-ToF camera system 206 can be expected to produce a depth estimation and intensity estimation of static scene 202 that is comparable to the ground-truth depth 208 and intensity 210 using conventional I-ToF imaging techniques.

However, when imaging dynamic scene 204 using conventional I-ToF imaging techniques, I-ToF camera system 206 can be expected to produce a depth estimation and intensity estimation that include motion artifacts when using a long integration time, and/or noise due to low SNR when using a shorter integration time. For example, depth map 212 and intensity image 214 were generated using conventional I-ToF techniques and a relatively long exposure time. As shown in FIG. 2, depth map 212 and intensity image 214 include motion artifacts due to misalignment between the correlation images (e.g., movement between frames) and/or movement of objects during integration of single correlation images (e.g., blurring within a single frame). As a more particular example, comparing the bottom callout from depth map 212 to the same portion of ground truth depths 208, motion artifacts can manifest as errors in portions of the depth map corresponding to portions of the scene that are in motion. Similarly, comparing the callouts from intensity image 214 to the same portions of ground truth intensity 210, motion artifacts can manifest as blurring in portions of the intensity image corresponding to portions of the scene that are in motion.

As another example, depth map 216 and intensity image 218 were generated using conventional I-ToF techniques and a relatively short exposure time. As shown in FIG. 2, depth map 216 and intensity image 218 include fewer motion artifacts due to misalignment between the correlation images (e.g., movement between frames) and/or movement of objects during integration of single correlation images (e.g., blurring within a single frame), but also include more noise. As a more particular example, comparing the callouts from depth map 216 to the same portions of ground truth depths 208, there are significant errors in depth map 216 regardless of whether that portion of the scene is in motion. Similarly, comparing the callouts from intensity image 218 to the same portions of ground truth intensity 210, noise can manifest as a loss of detail in the intensity image regardless of whether that portion of the scene is in motion.

As described below, in some embodiments, when imaging dynamic scene 204 using I-ToF imaging techniques that incorporate mechanisms described herein, I-ToF camera system 206 can be expected to produce depth estimates and intensity estimates of higher quality than those produced using the conventional I-ToF imaging techniques (e.g., estimates that do not include significant motion artifacts, and estimates that have a higher SNR). For example, depth map 220 and intensity image 222 were generated using I-ToF techniques that incorporate mechanisms described herein (including burst imaging techniques described below). As shown in FIG. 2, depth map 220 and intensity image 222 do not include motion artifacts seen in depth map 212, and are less impacted by noise than depth map 216. As a more particular example, comparing the bottom callout from depth map 222 to the same portion of ground truth depths 208 and the bottom callout from depth map 212, no motion artifacts are apparent in depth map 222. Similarly, comparing the callouts from intensity image 222 to the same portions of ground truth intensity 210 and intensity image 214, intensity image 222 does not include blurring in portions of the intensity image corresponding to portions of the scene that are in motion. As another more particular example, comparing the callouts from depth map 222 to the same portions of ground truth depths 208 and depth map 216, depth map 222 does not include significant noise (e.g., it is much closer to the ground truth than depth map 216). Similarly, comparing the callouts from intensity image 222 to the same portions of ground truth intensity 210 and intensity image 218, intensity image 222 does includes less noise (e.g., detail is produced with higher fidelity). Additionally, FIG. 2 includes motion estimations (XY motion estimates 224, and Z motion estimates 226) that were generated using the same data that was used to generate depth map 220 and intensity image 222. As described below, XY motion estimates 224 can be estimated based on a distribution of brightness in (potentially blurred) intensity images generated from two sets of correlation images. Additionally, Z motion estimates 226 can be estimated based on the XY motion estimates 224 and depth maps for each set of correlation images (e.g., depth map 220 and a corresponding depth map from a second set of correlation images). Such estimates cannot be reliable generated from either the long or short integration time correlation images used to generate depth maps 212, 216 and intensity images 214, 216, respectively.

As described above, time-of-flight (ToF) cameras are a popular sensing technology used to perceive the 3D world, conventional ToF cameras do not explicitly account for relative motion between objects in the scene and the camera during capture (e.g., if one or more objects is moving and/or if the camera is moving). Accordingly, for dynamic scenes, depth and intensity estimates generated using a ToF camera are often negatively impacted by motion artifact, especially under rapid motion, and/or low SNR due to shortened exposure times used to mitigate motion artifacts. For example, while motion artifacts can be reduced with short capture times (as shown in FIG. 2), reducing the capture time results in lower SNR, such that conventional ToF cameras generally exhibit a fundamental noise-vs-motion tradeoff.

In some embodiments, mechanisms described herein can at least partially overcome this tradeoff, and can facilitate estimation of scene depths and intensity that is free of motion artifacts (e.g., where the incidence of motion artifacts is greatly reduced). Additionally, mechanisms described herein can facilitate estimation of relatively high-resolution 3D scene motion (i.e., both lateral and axial motion). For example, as described below, mechanisms described herein can be used to estimate high-quality 3D geometry of a scene, intensity of the scene, and 3D motion in the scene simultaneously with a single ToF camera, which can facilitate use of ToF imaging for more applications in a dynamic 3D world.

In some embodiments, mechanisms described herein can be used with indirect ToF (I-ToF) imaging techniques. As an example, an I-ToF camera can be configured to emit continuously modulated light toward a scene, and capture images that encode a correlation between the reflected light and a demodulation function. In such an example, the magnitude of the recorded signal can reflect the correlation between the modulation function and demodulation function and the distance to the point from which the light was reflected (e.g., an object in the scene), among other factors (e.g., albedo, light source power, etc.). In this example, after capturing a set of correlation images with different demodulation functions, the I-ToF camera can estimate scene depth and intensity from the correlation image set. In a static scene, the light received at each pixel for each image is reflected from the same portion of the scene (e.g., the same point on the same object), and the correlation images are well aligned. However, for a dynamic scene, the light received at each pixel for each image may not be reflected from the same portion of the scene, as objects in the scene move relative to the camera as the series of correlation images is captured. Accordingly, the correlation images are not aligned due to the motion in the scene, leading to artifacts in the depth and intensity estimate when using conventional I-ToF imaging techniques.

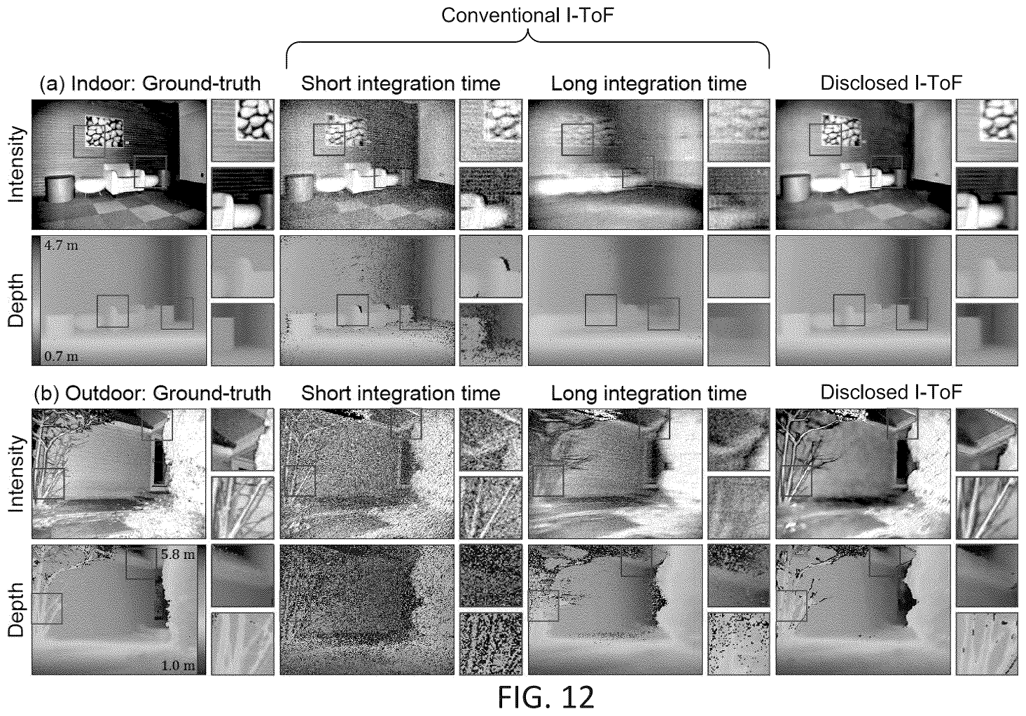

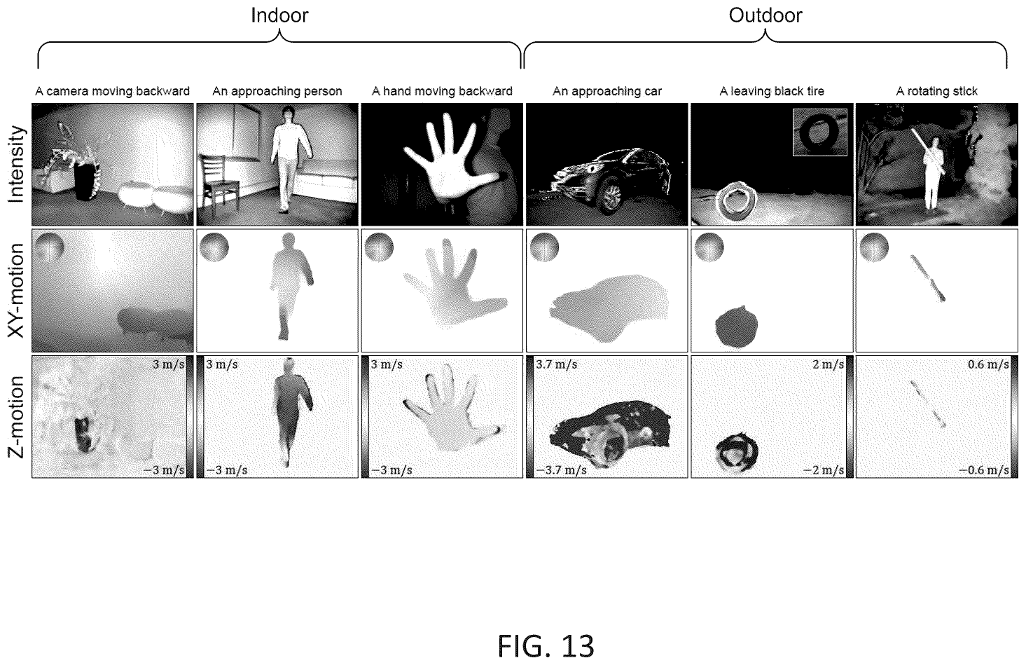

Modeling and estimating motion in I-ToF imaging is difficult, as the raw correlation images are spatio-temporally coded, and thus do not preserve brightness constancy, an inherent assumption for classical optical flow techniques. For example, images within a correlation image set that are captured using a different combination of modulation and demodulation signals can be expected to have different pixel values, even for the same scene point, because they are captured with different demodulation functions. As described below, the spatial gradient of an intensity image estimated from a correlation image set (although misaligned due to motion) can be expected to preserve brightness along the true motion. In some embodiments, mechanisms described herein can use information from two correlation image sets captured sequentially in time to estimate lateral motion in the scene based on the distribution of brightness encoded in the two correlation image sets. As described below, the preservation of brightness along the true motion of objects in the spatial gradient of the intensity image holds for relatively small motions (e.g., motion that satisfies the Taylor approximation well, which can be, in practice, up to about 4-5 pixels of motion between frames for the I-ToF camera used in the prototype described below in connection with FIGS. 12 and 13, corresponding to integration times of about 1-2 ms in the examples described below in connection with FIGS. 12 and 13), and motions that are linear (e.g., 3D motion that can be approximated relatively accurately by a single 3D vector, which can be motion that does not substantially curve or oscillate during generation of the set of correlation images) across the correlation image set, which may constrain use of mechanisms described herein to use with scenes that have relatively small and linear motion (e.g., the amount and/or type of motion in a scene to be analyzed can constrain whether mechanisms described herein are well suited for the task). Note as the magnitude of the motion increase and/or deviates from linear motion, the accuracy of the motion estimates can be expected to decrease (e.g., the average error between the true motion and the motion estimate can be expected to increase) using mechanisms described herein. However, even as the accuracy of motion estimates decreases, potentially degrading performance of mechanisms described herein compared to scenes with smaller and/or more linear motion, intensity images and/or depth estimates generated using mechanisms described herein can be expected to have higher SNR than intensity images and/or depth estimates generated from the same scene using conventional I-ToF techniques (as well as motion estimates that are more accurate than a motion estimate calculated from any data generated using conventional I-ToF techniques). In some embodiments, mechanisms described herein can use relatively short integration times when imaging dynamic scenes, as shortening the integration time can reduce the magnitude of motion within a set of correlation images, and an impact of non-linear motions can be mitigated (e.g., as a non-linear motion can be approximated relatively accurately as a sequence of linear movements). Additionally, using relatively short integration times (e.g., relative to the magnitude of scene motion) can also facilitate real-time motion estimation that is approximately instantaneous (e.g., approximating a direction and magnitude of motion at a particular instant in time). For example, in some embodiments, mechanisms described herein can capture correlation images using an integration time of about 1 to 2 milliseconds (ms).

While reducing the integration time can limit motion in the scene to small and linear motions, reducing the integration time also can be expected to reduce the SNR. In some embodiments, mechanisms described herein can be used to implement an I-ToF burst imaging technique that computationally (not optically) increases the integration time of correlation images, thereby preventing motion artifacts caused by longer optical integration times, while increasing SNR relative to short exposure times, which can further mitigate the tradeoff between noise and motion tradeoff. Obtaining high-quality depth and intensity estimates from the higher SNR correlation images generated using such a technique can further improve the accuracy of motion estimates.

FIG. 3 shows an example of a static scene and a dynamic scene, with correlation images generated from the two scenes using conventional indirect time-of-flight techniques, as well as depth and intensity estimates generated using conventional indirect time-of-flight techniques, and a comparison of the quality of depth estimates generated using conventional indirect time-of-flight techniques with short and long integration times to a depth estimates generated using indirect time-of-flight techniques implemented in accordance with some embodiments of the disclosed subject matter. In general, I-ToF cameras can capture a set of correlation images of a scene to estimate depth in the scene and an intensity image of the scene. As shown in FIG. 3, although I-ToF cameras provide correct depth and intensity information for static scenes using conventional I-ToF techniques, estimated depth and intensity information for dynamic scenes estimated using conventional I-ToF techniques suffer from motion artifacts due to misalignment between the correlation images.

As described above in connection with FIG. 1, an I-ToF camera can include of a light source and a sensor. The intensity of the light source can be temporally modulated by a periodic modulation function M(t) with period T₀. The light emitted by the light source can travel to a scene of interest and is reflected back toward the sensor by objects in the scene. Each sensor pixel p computes a correlation C(p) between the radiance of the light incident on p and a periodic demodulation function D(t) which has the same period as M(t). Several modulation M(t) and demodulation functions D(t) can be used to compute C(p). For example, sinusoids can be used for M(t) and D(t). I-ToF image formation is generally described herein in connection with a unipolar sinusoidal demodulation function (0≤D(t)≤1), as noise analysis is simplified (e.g., compared to more complex demodulation functions, such as a bipolar sinusoidal demodulation function used with a sinusoidal modulation function, or other modulation/demodulation schemes that can be used for I-ToF (e.g., using square functions, triangular functions, ramp functions, etc.). Note that the same analysis that is described below can be extended to at least bipolar sinusoidal demodulation functions (e.g., where −1≤D(t)≤1, see Appendix A, which has been incorporated herein by reference), and can be expected to apply to additional modulation/demodulation schemes for I-ToF, such as modulation and/or demodulation functions based on square functions, triangular functions, ramp functions, etc.).

For example, a sinusoidal modulation signal M(t) and unipolar sinusoidal demodulation function D(t) can be expressed using the following expressions:

$$M ( t ) = 1 + cos ( 2 π {f}_{0} t ) , D ( t ) = \frac{1}{2} + \frac{1}{2} cos ( 2 π {f}_{0} t ) , \qquad ( 1 )$$

where the modulation frequency f₀=1/T₀. In this example, C(p) can be expressed as:

$${C}_{n} ( p ) = \frac{T}{2} ( {e}_{s} + {e}_{a} + \frac{{e}_{s}}{2} cos ( \frac{4 π {f}_{0} Z}{c} - {ψ}_{n} ) ) , \qquad ( 2 )$$

where T is the integration time; c is the speed of light; Z is the scene depth between the camera and the scene point imaged at p; eₛ and eₐ are the average number of photo-electrons generated at the sensor per unit time by the light source and ambient light (e.g., sunlight), respectively;

$${ψ}_{n} = \frac{2 π ( n - 1 )}{N} ,$$

n∈{1, . . . , N} is the phase shift of D(t) by N(≥3) times to decode three unknowns eₛ, eₐ, and Z from a set of N measured correlation images Cₙ(p). Note that the (p) in Cₙ(p) is dropped for brevity in expressions below. Appendix A includes a derivation of EQ. (2). Note that the value of Cₙ changes according to ψₙ even for the same scene point.

Given a set of N correlation values (e.g., calculated using EQ. (2)), the estimated scene depth Z and intensity I for pixel p can be expressed as:

$$\hat{Z} = \frac{c}{4 π {f}_{0}} {tan}^{- 1} ( \frac{{\sum }_{n = 1}^{N} {C}_{n} sin {ψ}_{n}}{{\sum }_{n = 1}^{N} {C}_{n} cos {ψ}_{n}} ) , \\ and \qquad ( 3 )$$

$$\hat{I} = \frac{1}{N} \sqrt{{( {\sum }_{n = 1}^{N} {C}_{n} cos {ψ}_{n} )}^{2} + {( {\sum }_{n = 1}^{N} {C}_{n} sin {ψ}_{n} )}^{2}} ∝ {Te}_{s} . \qquad ( 4 )$$

As can be seen in EQ. (4), the intensity I is proportional to the amount of incident signal photons, which is proportional to the scene albedo and exposure time T. Additionally, intensity I is inversely proportional to the squared depth (e.g., assuming that the light source is a point source). By computing EQS. (3) and (4) for all pixels, a depth map and an intensity image can be generated using the correlation values calculated using EQ. (2). Note that since Cₙ is periodic (see EQ. (2)), the maximum measurable depth range Zₘₐₓ without ambiguity can be expressed as:

$${Z}_{m ax} = \frac{c}{2 {f}_{0}} . \qquad ( 5 )$$

Note that although modulation frequency is generally used interchangeably herein with fundamental frequency when describing unambiguous depth range. some modulation and/or demodulation functions (e.g., some non-sinusoid functions, such as square waves) can include multiple modulation frequencies. For such functions, the modulation frequency f₀ that determines the unambiguous depth range is generally the fundamental frequency of the of function.

The example in FIG. 3 includes a depiction of a static scene 302, a set of correlation images 304 of static scene 302 (e.g., including images C₁ to C_{N} captured during N measurement periods) generated using conventional I-ToF techniques (e.g., using EQ. (2)), a depth map 306, and an intensity image 308 generated using correlation images 304 and conventional I-ToF techniques.

Note that since Cₙ (EQ. (2)) suffers from Poisson noise, the estimated Z and/by EQS. (3) and (4) differ from the true Z and/of the scene (shown for a portion of scene 302 within box 310 in ground truth depth 322), as can be observed in the depth estimates based on a comparison of 306 and 322. The quality of the Z and/estimates can be quantified by the SNR, which can be expressed as:

$${SNR}_{Z} = \frac{Z}{{σ}_{Z}} = \frac{2 π {f}_{0}}{c} \frac{\sqrt{T} {e}_{s} Z}{\sqrt{{e}_{s} + {e}_{a}}} \qquad ( 6 )$$

with Z assumed to be not equal to zero (i.e., Z≠0), and

$${SNR}_{I} = \frac{1}{{σ}_{I}} = \frac{\sqrt{T} {e}_{s}}{2 \sqrt{{e}_{s} + {e}_{a}}} , \qquad ( 7 )$$

for the Z and I estimates, respectively, when N=4 (see Appendix A for derivations of EQS. (6) and (7)). σ_{Z} and σ_{I} are standard deviations of the Z and I estimates due to noise. Note that in the static scene, higher quality depth and intensity estimates are possible by increasing the integration time T and source strength eₛ, and decreasing the ambient strength eₐ. Additionally, increasing the modulation frequency f₀ can improve the SNR of depth estimates, but reduces the maximum unambiguous depth range (see EQ. (5)).

The example in FIG. also 3 includes a depiction of a dynamic scene 312, a set of correlation images 314 of dynamic scene 312 (e.g., including images C₁ to C_{N} captured during N measurement periods) generated using conventional I-ToF techniques (e.g., using EQ. (2)), a depth map 316, and an intensity image 318 generated using correlation images 314 and conventional I-ToF techniques.

In addition to Poisson noise in the correlation images, scene and/or camera motion also prevents correct depth and intensity estimates. Note that EQS. (3) and (4) assume there is no motion while capturing the N correlation images. If the correlation images are not aligned due to motion, the depth and intensity images estimated by EQS. (3) and (4) also include motion artifacts, as shown in depth map 316 and intensity image 318. The motion artifacts are exacerbated with larger motion and/or longer integration times. Note that in the dynamic scene, the impact of motion artifacts in the depth and intensity estimates can be reduced by decreasing the integration time T, but this reduces the SNR, as indicated in EQS. (6) and (7).

Note that depth estimates of the dynamic scene obtained via conventional I-ToF imaging suffer from noise and/or motion artifacts regardless of the integration time (e.g., motion artifacts increase as integration time T increases, and noise increases as integration time T decreases). In contrast, using mechanisms described herein, high-quality 3D geometry can be recovered without significant motion artifacts (e.g., compared to using a longer integration timed with conventional I-ToF techniques), and with reduced noise (e.g., compared to using a similar or shorter integration time with conventional I-ToF techniques).

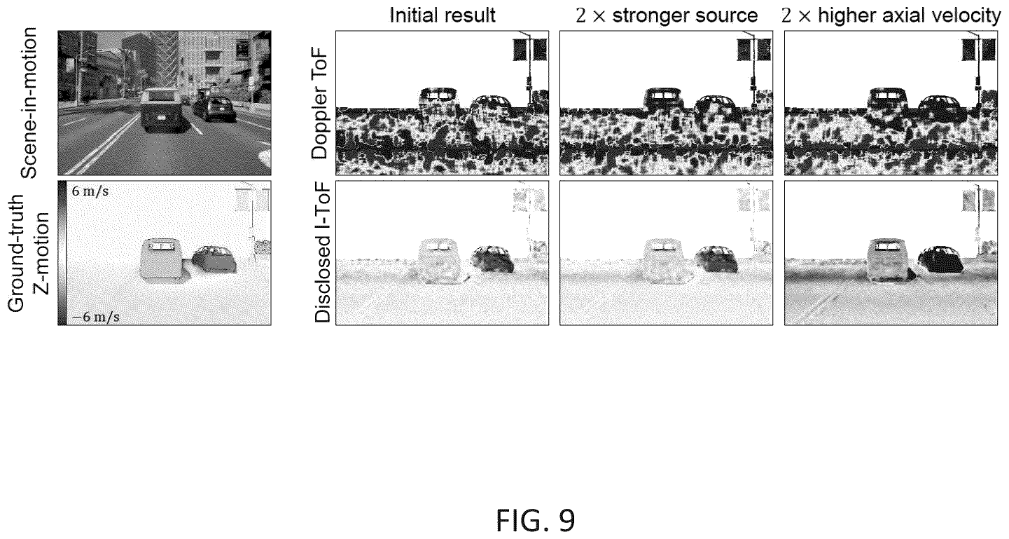

Note that the scenes and results depicted in FIG. 3 (as well as scenes and results depicted in FIGS. 9 to 11), are based on simulations, which can facilitate quantitative comparison of techniques described herein with the ground-truth and alternative techniques (e.g., conventional I-ToF techniques). Simulations were also be performed for various motion scenarios and imaging parameters, such as modulation frequency, integration time, and lighting conditions. Indoor scenes were modeled using POVray, a ray tracing tool, and outdoor scenes were modeled using the CARLA simulator. Appendix A includes additional details related to the simulations, such as parameter values used for the different simulation results.

In FIG. 3, dynamic scene 312 is static scene 302 with camera motion during imaging, with ground truth 322 depicting the true depths of the simulated scene in box 310. The example in FIG. 3 includes comparison depth maps 324, 326, and 328 generated using various I-ToF techniques. For example, depth map 324 was generated from correlation images 314 using conventional I-ToF techniques, and depth map 326 was generated from a set of correlation images of dynamic scene 312 with longer integration times and using conventional I-ToF techniques. As another example, depth map 328 was generated from a set of correlation images of dynamic scene 312 with short integration times (similar to the short exposure time described above in connection with FIG. 2) and using mechanisms described herein to estimate motion in the scene (including burst imaging techniques described below), and align data from the set of correlation images prior to generating depth map 328. Note that the three numbers underneath depth maps 324, 326, and 328 show the percent fraction of inlier pixels that lie within 0.5%, 1%, and 2% of the true depths. As shown in FIG. 3, depth map 328 is a higher quality estimate than either of depth map 324 (which includes depth errors caused by low SNR in the correlation images) and depth map 326 (which includes depth errors caused by motion artifacts). For example, as shown in connection with depth map 324, while decreasing the integration time can reduce motion artifacts in conventional I-ToF techniques, it also leads to noisier depth estimates. As another example, as shown in connection with depth map 326, while the extended integration time reduces noise, extending the integration time also introduces motion blur. By contrast, as shown in connection with depth map 328, using mechanisms described herein can generate depth estimates that effectively mitigate both noise and motion artifacts.

FIG. 4A shows an example of two sets of correlation images generated using indirect time-of-flight techniques with a position of a dynamic scene point p reflected in each correlation image, and representations of spatial gradients generated from each set of correlation images in accordance with some embodiments of the disclosed subject matter. FIG. 4A includes two correlation images sets, a first correlation image set 402 (e.g., including correlation images labeled C_{1,1} to C_{1,N}) and a second correlation image set 404 (e.g., including correlation images labeled C_{2,1} to C_{2,N}). FIG. 4A also includes two blurred intensity images 412 and 414 generated from correlation image set 402 and correlation image set 404, respectively, without aligning the individual correlation images within each set. In the example, all correlation images in sets 402 and 404 have different pixel values (depicted as distinct shades) along the true XY-motion (ΔX, ΔY), posing a challenge for conventional motion estimation techniques. Correlation image set 402 and correlation image set 404 are shown in FIG. 4A as being captured using modulation frequencies f₁ and f₂. In some embodiments, f₁ and f₂ can be the same frequency (e.g., f₁=f₂), or different frequencies (e.g., f₁≠f₂, as described below in connection with multi-frequency coding).

As described above, blurred intensity images can be generated by based on the intensity at the same pixel, for each pixel. For example, the intensity at pixel (1,1) in intensity image 412 can be based on the correlation value at pixel (1,1) in each of the correlation images in correlation image set 402 (e.g., calculated using correlation values Cₙ (1,1) for pixel (1,1) in EQ. (4) to calculate an intensity for pixel (1,1) in the intensity image). If the scene motion during capture time Δt is relatively small and linear (e.g., as described above in connection with FIG. 2), a model representing the distribution of intensity in intensity images 412 and 414 (e.g., spatial gradients ∇I₁ and ∇I₂, respectively) obtained from each correlation image set can be expected to maintain the pixel values (represented by the same color) along the motion, facilitating XY-motion estimation. Additionally, depth values (one from each set) can be obtained along the estimated XY-motion, and the difference in depth can be used to estimate the Z-motion (AZ) for the portion of the scene corresponding to the point.

Motion estimation techniques for conventional camera images (e.g., conventional optical flow techniques) often assume that brightness of a scene point is conserved across multiple conventional images captured in sequence. However, raw correlation images Cₖ=C_{k,n} (n∈{1, . . . , N}) (e.g., correlation images in set 402 or correlation images in set 404) are spatio-temporally coded, and do not conserver brightness (e.g., due to axial motion and/or differences in the combination of modulation function and demodulation function associated with each correlation image being different), and therefore generally are not consistent with the assumption that brightness of the same point is conserved. For example, since all correlation images in each set of correlation images are expected to have different brightness values even for the same scene point (see, e.g., FIG. 3, correlation image sets 304 and 314), it is challenging to accurately estimate lateral XY-motion using conventional optical flow techniques directly on the correlation images.

As described herein, when consider two neighboring correlation image sets under small and linear scene motion, XY-motion can be estimated precisely based on brightness conservation of aggregated information from the set of correlation images. Note that many I-ToF cameras provider a temporal stream of correlation images sets (e.g., C₁, C₂, . . . , C_{K}) of a scene.

For example, consider two correlation image sets captured successively in time, as shown in FIG. 4A. If the scene motion is small and linear over the two correlation image sets, values of the spatial gradient of the intensity image obtained from each correlation image set (although misaligned due to motion) are maintained along the true XY-motion over the two intensity images (sometimes referred to herein as Observation 1). Note that the spatial gradient can be referred to, and treated as, an image (e.g., a spatial gradient image), and values of the spatial gradient image can be referred to as brightness values, in which case the pixel brightness of the spatial gradient images can be characterized as being maintained along the true XY-motion in the scene. See Appendix A, section A3 for further details related to Observation 1. Note that Observation 1 holds regardless of whether unipolar or bipolar demodulation functions are used.

Under particular scene conditions (small and linear motion), Observation 1 is expected to apply even if all correlation images in each set have different brightness values along the true XY-motion, as the spatial gradient of an intensity image (e.g., as described above in connection with EQ. (4)) obtained from each set preserves its value along the motion if the scene motion is small and linear. Note that due to scene motion, the absolute value of the estimated intensity image may not preserve its brightness even along the true motion, as further described in Appendix A. Note that if there is scene motion, portions of the intensity image corresponding to portions of the scene that include motion are blurred due to the scene motion. Observation 1 can be expressed as:

$$\frac{\partial \vert ∇ I \vert}{\partial X} Δ X + \frac{\partial \vert ∇ I \vert}{\partial Y} Δ Y + \frac{\partial \vert ∇ I \vert}{\partial t} Δ t = 0 , \qquad ( 8 )$$

where I is the blurred intensity image (e.g., generated using EQ. (4)) and

$$∇ = {( \frac{\partial }{\partial X} , \frac{\partial }{\partial Y} )}^{T}$$

denotes the spatial gradient, with

$$\frac{\partial }{\partial X} ( \cdot ) , \frac{\partial }{\partial Y} ( \cdot ) \frac{\partial }{\partial t} ( \cdot )$$

representing the partial derivatives with respect to X, Y, and time, respectively. Note that ΔX, ΔY, and Δt are the X-motion, Y-motion, and time step between the blurred intensity images as shown in FIG. 4A. In some embodiments, the spatial gradient (e.g., ∇I) can be formatted as a 2D array with the same size as the intensity image I, and each position in the 2D array can include a pair of values representing the gradient along the x- and y-directions. For example, each element in the 2D array can include a value (e.g., a value a(p)) representing the rate of change in intensity horizontally in the scene at p (e.g., in the camera frame), and a second value (e.g., a value b(p)) representing the rate of change in intensity vertically in the scene (e.g., in the camera frame). In such an example, a direction of maximum intensity (in the camera frame) can be characterized as

$$∠ ( ∇ I ( p ) ) = arctan ( \frac{b}{a} ) ,$$

and the magnitude of the maximum intensity increase can be characterized as r(∇I(p))=\sqrt{a²+b²}. Note that the preceding example describes one way of representing the magnitude and intensity of the gradient at a particular point (e.g., as a complex number), and any other suitable format can be used to represent the gradient magnitude and intensity of the gradient and/or the gradient along the x- and y-directions, such as a magnitude value and a direction value (e.g., r(p) and ∠(p)), etc.). Additionally or alternatively, the spatial gradient (e.g., ∇I) can be formatted as a 3D array with positions along the x- and y-directions represent positions p, and positions along the z-direction represent different values representative of the gradient at p (e.g., a values can be stored at positions with z=1 and b values can be stored at positions with z=2, magnitude values can be stored at positions with z=1 and direction values can be stored at positions with z=2, etc.). Note that intensity image I from EQ. (4) is based on contributions from signal photons (e.g., photons emitted from light source 102), while conventional images used in conventional optical flow record all photons, including background photons (e.g., light, such as sunlight reflected from the scene), and any photons emitted by a light source, such as a flash.

Note that Observation 1 is powerful, as it allows use of many conventional optical flow algorithms to estimate dense XY-motion from correlation image data by operating on spatial gradients of intensity images obtained from I-ToF correlation image sets, rather than on the correlation images directly. For example, an optical flow technique can be used to determine correspondence between particular portions of spatial gradients generated from multiple sets of correlation images captured sequentially (e.g., based on ∇I₁ and ∇I₂, in FIG. 4A), and because the spatial gradients correspond to the intensity images, the XY-motion determined from the spatial gradients can be directly mapped to the intensity images (e.g., I₁ and I₂, in FIG. 4A).

After estimating the XY-motion between the blurred intensity images (e.g., based on the corresponding spatial gradients), finer grained XY-motion between successive correlation images can be obtained by interpolation (e.g., as shown in FIG. 4A). For example, the motion in the scene during capture of correlation images C₁ is (at least assumed to be) small and linear, the motion between the individual correlation images can be interpolated as a fraction of the XY motion between the sets of correlation images based on the time between the correlation images, and the XY motion over Δt. In some embodiments, each correlation image (e.g., in correlation image sets 402 and/or 404) in can be generated using a relatively short integration time (e.g., in a range of about 1 ms to about 5 ms, such as about 1 ms, about 2 ms, about 3 ms, about 4 ms, or about 5 ms). In some embodiments, each correlation image set can be captured in a relatively short period of time (e.g., Δt can be in a range of about 8 ms to about 16 ms for integration times of about 1 to 2 ms with a roughly equal amount of time between integration times). For example, the total time to capture the set of correlation images can be approximately equal to the sum of the integration time for each correlation image (e.g., about 4 ms to about 8 ms when capturing four correlation images with integration times in a range of about 1 ms to 2 ms) and the time between integration of correlation images (e.g., used to read out data, reset pixels, etc.), which can be referred to as a dead time, readout period, reset period, etc., which can be relatively short (e.g., about the same as the integration time).

Estimating XY-motion using two correlation image sets under small and linear motions (e.g., as described herein) has several benefits, such as: while conventional approaches estimate motion between all neighboring correlation images independently using optical flow techniques, using mechanisms described herein, motion can be estimated more efficiently based on flow between as few as two aggregate representations of the correlation images (e.g., rather than at least N−1 optical flow estimates if one were to attempt to estimate motion from a set of N conventional correlation images); and Z-motion in the scene can be estimated using depth difference along the XY-motion.

In some embodiments, the estimated XY-motion between the intensity images (e.g., based on EQ. (8)) can be used to align the intensity information in the correlation images within a set of correlation images (e.g., in accordance with the finer-grained motion between correlation images). For example, an intensity value at a particular pixel position p (e.g., a pixel at (xᵢ, yⱼ)) in a refined intensity image I′ and a depth estimate Z can be based on the values of pixels in correlation images along the line of motion (e.g., based on the values of pixels at positions

$${C}_{1 , 1} ( {x}_{i} , {y}_{j} ) , {C}_{1 , 2} ( {x}_{i} + \frac{Δ X}{Δ t / N} , {y}_{j} + \frac{Δ Y}{Δ t / N} ) , … , {C}_{1 , 2} ( {x}_{i} + N \frac{Δ X}{Δ t / N} , {y}_{j} + N \frac{Δ Y}{Δ t / N} ) ) .$$

For example, after aligning two correlation image sets along the estimated XY-motion, motion and artifact-free depth and intensity images can be obtained for the two correlation image sets. In some embodiments, Z-motion between correlation images can also be compensated for using two correlation image sets together. Alternatively, in some embodiments, under the small motion constraint, the Z-motion within each correlation image set can be ignored, and depth and intensity estimates can be generated using EQS. (3) and (4) based on the values of a set of pixels identified using the estimated XY-motion (e.g., as described above).

In some embodiments, after determining the XY-motion, mechanisms described herein can be used to generate two aligned depth maps (e.g., based on EQ. (3) and the values of a set of pixels identified using the estimated XY-motion as described above). Additionally, in some embodiment, using the two depth maps (e.g., Z₁ and Z₂ from correlation image sets 402 and 404 in FIG. 4A), mechanisms described herein can be used to estimate the axial motion (e.g., motion along the Z direction) based on the difference between the depth of the same scene point in the two depth maps (e.g., the Z motion, ΔZ for the object at pixel C_{1,1}(xᵢ, yⱼ) and C_{2,1}(xᵢ+ΔX,yⱼ+ΔY) can be based on the difference between the two depths, such as ΔZ=Z₂(xᵢ+ΔX,yⱼ+ΔY)−Z₁ (xᵢ,yⱼ)). Note that although the Z-motion is derived using two depth maps, it can be approximated well as instantaneous motion with a short integration time (e.g., as described above in connection with FIGS. 2 and 3).

As described above, Observation 1 facilitates reliable XY-motion estimation with brightness-varying correlation images, and the application of Observation is described above as being based on a motion constraint (e.g., that motion should be small and linear while capturing two neighboring correlation image sets). This constraint can be satisfied by reducing the integration time, albeit at the cost of low SNR of the resulting depth and intensity estimates (see, e.g., EQS. (6) and (7)). In some embodiments, techniques described above in connection with EQ. (8) in combination with one or more additional techniques (e.g., multi-frequency coding described below, burst imaging described below), can be used to generate an intensity image(s), a depth map(s), and/or motion estimates with improved SNR, as low SNR in the correlation images (e.g., leading to low SNR in the intensity images and/or depth maps) can lead to degraded performance when using the data to analyze the scene (e.g., for motion estimation, object detection, geometry characterization, etc.). For example, inaccurate depth and intensity estimates can lead to imprecise Z-motion and XY-motion estimates as well.

In some embodiments, mechanisms described herein can use a multi-frequency coding scheme to increase the SNR of the depth and Z-motion estimates. For example, using modulation functions with different frequencies to capture successive sets of correlation images (e.g., in the example of FIG. 4A with f₁≠f₂). As shown in EQS. (5) and (6), the SNR of the depth estimates can be improved by increasing the modulation frequency at the cost of the reduced measurable depth range. In some embodiments, mechanisms described herein can achieve high-depth precision and a large depth range simultaneously using multiple modulation frequencies. For example, two different modulation frequencies (e.g., f₁ and f₂) can be used to two neighboring correlation image sets (e.g., sets 402/C₁ and 412/C₂, respectively, in FIG. 4A). After obtaining two interim ambiguous depth maps (e.g., ambiguous due to the relatively short maximum depth from the higher frequency modulation function) from the two correlation image sets, a final unambiguous depth map can be decoded from the information in the two ambiguous depth maps. For example, if the scene has a maximum depth, Zₘₐₓ′, such that Zₘₐₓ′ is greater than Zₘₐₓ(f₁) and greater than Zₘₐₓ(f₂), each depth map is ambiguous, as depths between Zₘₐₓ(f₁)/Zₘₐₓ(f₂) and Zₘₐₓ′ alias with depths less than or equal to Zₘₐₓ′.

Note that conventional multi-frequency schemes used for I-ToF generate one final depth map from two interim depth maps. In some embodiments, mechanisms described herein can recover two depth maps from two correlation image sets to facilitate recovery of the Z-motion in the scene. Appendix A includes additional details related to multi-frequency coding. In some embodiments, mechanisms described herein can use two relatively high frequencies (e.g., frequencies in a range of about 1 megahertz (MHz) to 300 MHz, or 5 MHz to 300 MHz) for the two correlation image sets to achieve two high-SNR depth maps, and thus, a high-quality Z-motion estimate as well, as even with the two correlation image sets captured with different frequencies, XY-motion can still be estimated accurately based on Observation 1 (see Appendix A). In some embodiments, the difference between the two frequencies can be relatively small, for example, a difference of about 5 to 10 MHz. Note that some conventional multi-frequency coding may use a larger frequency difference between the two frequencies.

Note that although multi-frequency schemes can improve the depth accuracy in many scene conditions (e.g., scenes with objects moving relatively slowly, scenes with high albedo objects, etc.), such a scheme may not sufficiently improve SNR in extremely low SNR scenarios (e.g., scenes that include low albedo objects, thin objects, scenes with faster motion requiring decreased integration times, etc.), as severe noise in the interim depth estimates can prevent correct depth decoding. As described below, mechanisms described herein can use burst imaging techniques to improve SNR of depth estimates in a complementary manner to multi-frequency coding, which can facilitate improved depth and/or intensity estimates alone (e.g., in combination with techniques described above in connection with EQ. (8)), or in combination with multi-frequency coding (and any other suitable techniques that can improve SNR of the interim depth estimates).

FIG. 4B shows an example of a dynamic scene, and motion estimates generated from correlation images generated using conventional indirect time-of-flight techniques and motion estimates generated from spatial gradients based on sets of correlation images in accordance with some embodiments of the disclosed subject matter. The example in FIG. 4B includes a depiction of a dynamic scene 422, XY-motion estimates 424 generated using conventional optical flow techniques to estimate XY-motion in the scene directly from raw correlation images of dynamic scene 422, XY-motion estimates 426 generated using mechanisms described herein, Z-motion estimates 426 generated by comparing depth maps generated from raw correlation images of dynamic scene 422 without alignment, and Z-motion estimates 428 generated using mechanisms described herein (e.g., including multi-frequency and burst techniques described herein). As shown in FIG. 4B, using mechanisms described herein, the SNR of both XY and Z-motion estimates are improved.

In some embodiments, a higher quality set of correlation images that include information from a relatively longer period of time can be generated from multiple sets of correlation images with much shorter integration times which can be used in connection with indirect time-of-flight techniques and burst imaging techniques implemented in accordance with some embodiments of the disclosed subject matter.

The root cause of low SNR in depth and intensity estimates calculated from conventional I-ToF techniques in challenging conditions (e.g., dynamic scenes) is the short integration time used to improve the SNR in motion estimation. While mechanisms described herein can improve intensity and/or depth estimation performance (e.g., improve SNR) for dynamic scenes using techniques described above (e.g., XY-motion estimation with improved SNR from spatial gradients of blurred intensity estimates, Z-motion estimation with improved SNR from using multi-frequency coding), in extremely low SNR scenarios, the SNR of intensity and/or depth estimates can be significantly reduced.

In some embodiments, mechanisms described herein can utilize burst imaging techniques to increase the SNR of motion and intensity estimates without optically extending the integration time of the correlation images (and thereby increasing motion artifacts in dynamic scenes) using burst imaging techniques, which can computationally increasing the integration time to enhance SNR without introducing the motion artifact. For example, burst imaging techniques; can include capturing a burst of images, each with a short capture time, and aligning and merging the image data from the set of images along the motion trajectory to increase the SNR. Burst denoising is generally computationally efficient enough to be implemented in real-time, even on smartphones.

In some embodiments, mechanisms described herein can use burst imaging to enhance the SNR of correlation images and thus, the resulting depth and intensity estimates. For example, a set Cₖ′ of burst correlation image (e.g., including burst correlation images C_{k,1}′ to C_{k,N}′ that includes N correlation images that are each based on M correlation images captured with the same modulation frequency and demodulation phase shift. For a particular reference correlation image (e.g., a correlation image C_{15,1} continuing the index in FIG. 4A), a burst of the correlation images used to generate a burst correlation image C_{15,1}′ can include correlation images captured with the same modulation frequency and phase shift from a stream of captured frames (e.g., {C_{15-((M-1)/2),1}, . . . , C_{15,1} . . . , C_{15+((-1)/2),1}} for odd values of M). The correlation images in the burst can be aligned and merged to increase the SNR of the reference image (which is sometimes referred to herein as a burst correlation image). Note that if multiple frequencies are used to generate correlation images, the correlation images from the stream of captured frames that are available for generating a higher quality correlation image (e.g., a burst correlation image) can differ based on the frequency of the modulation and/or demodulation functions used to generate the various correlation images. For example, if two frequencies (e.g., f₁ and f₂) are used to generate alternating sets of correlation images (e.g., as shown in FIG. 4A), correlation images used to generate a burst correlation image C_{15,1}′ can include correlation images correlation images from alternating sets of correlation images captured with the same modulation frequency and phase shift from the stream of captured frames (e.g., {C_{15-(M-1),1}, C_{15-(M-3),1}, . . . , C_{15,1} . . . , C_{15+(M-1),1}} for odd values of M). Appendix A includes additional description of using burst imaging techniques in connection with mechanisms described herein.

FIG. 5 shows an example of a process 500 for concurrently estimating motion, depth, and/or intensity of a scene using an indirect time-of-flight imaging system in accordance with some embodiments of the disclosed subject matter.

As shown in FIG. 5, process 500 can start at 502 with an index k equal to 1. Note that index k is used herein for convenience, and such an index can be omitted in some implementations of the disclosed subject matter, and/or can be initiated at a different value.

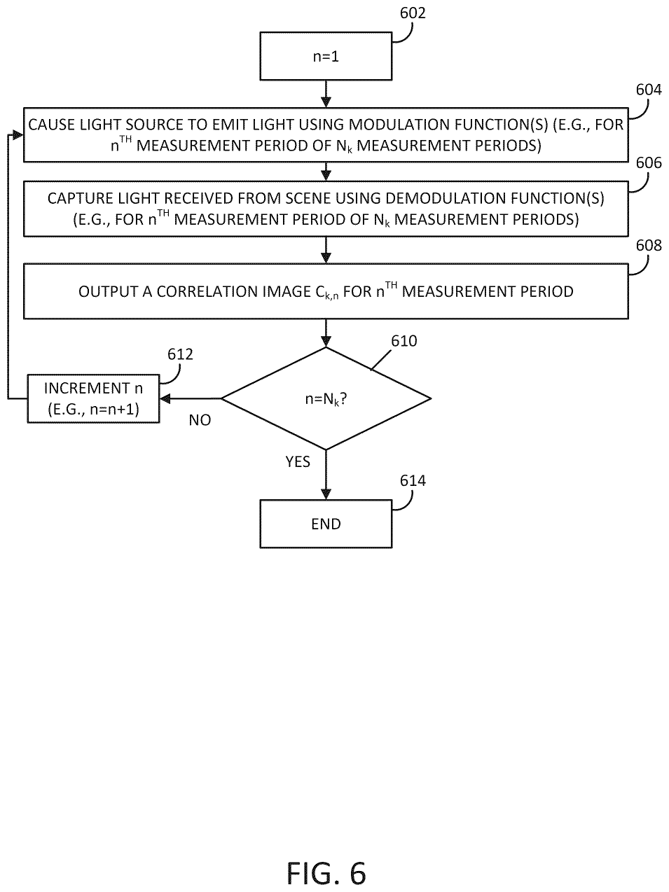

At 504, process 500 can generate a set of correlation images Cₖ that includes Nₖ correlation images from a scene with an integration time Tₖ using indirect time-of-flight (I-TOF) techniques. In some embodiments, a correlation image C_{k,n} can be generated based on modulated light emitted toward a scene based on a modulation function M(t) and captured using an image sensor based on a demodulation function D(t) after being reflected from objects in the scene. In some embodiments, any suitable technique or combination of techniques can be used to generate correlation images, such as techniques described above in connection with FIGS. 1 to 4B, and/or below in connection with process 600 of FIG. 6.

At 506, process 500 can generate an intensity image Iᵢ based on correlation images in the set of correlation images Cₖ. In some embodiments, process 600 can use any suitable technique or combination of techniques to generate the intensity image, such as using a technique based on EQ. (4) (e.g., an intensity image Iₖ for the k^{th} set of correlation images can be based on

$${I}_{k} ( p ) = \frac{1}{N} \sqrt{{( {\sum }_{n = 1}^{N} {C}_{k , n} ( p ) cos {ψ}_{n} )}^{2} + {( {\sum }_{n = 1}^{N} {C}_{k , n} ( p ) sin {ψ}_{n} )}^{2}} ,$$

where C_{k,n}(p) is the value for pixel p in the n^{th} correlation image in Cₖ). Note that for parts of the scene that are moving relative to the image sensor, the intensity image Iₖ is likely to be blurred, and the intensity image Iₖ generated at 506 can be referred to as a blurred intensity image.

At 508, process 500 can generate a model that represents a distribution of intensity across Iᵢ. In some embodiments, process 500 can generate any suitable model of the intensity image Iᵢ that preserves the relationship between intensity in different portions of the intensity image Iᵢ. For example, as described above in connection with EQ. (8), process 800 can calculate a spatial gradient, ∇Iᵢ, of the blurred intensity image, which can encode the spatial distribution of intensity at each portion of the scene (e.g., at each pixel of the intensity image Iᵢ). Note that other models of the intensity image that conserve values (e.g., brightness) can also be used in lieu of the spatial gradient.

If at least two sets of correlation images have not been generated of the current scene (“NO” at 510), process 500 can move to 512. For example, in the particular example of FIG. 5, if index k is greater than or equal to two, process 500 can determine that at least two sets of correlation images have been generated. At 512, process 500 can increment index k by one, and process 500 can return to 504. Note that this is an example, and any suitable technique can be used to determine whether to capture at least one more set of correlation images before estimating motion (e.g., at 514, or 514 and 520), generating a refined intensity image (e.g., at 516), and/or generating a depth map (e.g., at 518). Alternatively, in some embodiments, process 500 can generate a motion estimate (e.g., at 514, or 514 and 520), a refined intensity image (e.g., at 516), and/or a depth map (e.g., at 518) after generating only a single set of correlation images, and such information can be discarded, ignored, etc.

Otherwise, if at least two sets of correlation images have not been generated of the current scene (“YES” at 510), process 500 can move to 514.

At 514, process 500 can estimate lateral motion of portions of the scene based on correlations between the models. In some embodiments, process 500 can generate an estimate of lateral motion for different portions of the scene based on correlations between the models using any suitable technique or combination of techniques. For example, process 500 can use any suitable optical flow technique to estimate local and/or global motion in the scene based on correlations between models of intensity images generated from different (e.g., sequentially captured) sets of correlation images (e.g., Cₖ and Cₖ₋₁, Cₖ and Cₖ₊₁, Cₖ₊₁ and Cₖ₊₂, etc.). In a more particular example, process 500 can use optical flow techniques to determine an estimate of XY motion for each portion of the scene based on the information in the spatial gradient of each intensity image (e.g., optical flow between ∇Iₖ and ∇Iₖ₋₁).

In some embodiments, process 500 can estimate lateral motion for any suitable portions of the scene, such as portions corresponding to individual pixels, groups of pixels, etc. For example, process 500 can generate an estimate of XY motion for each pixel of intensity image Iₖ and/or for each pixel of intensity image Iₖ₋₁. Examples of XY motion estimates generated using mechanisms described herein are shown in FIGS. 2, 4B, 11, and 13. Note that while examples described herein generally use information from two neighboring sets of correlation images, information from non-neighboring sets of correlation images and/or more than two sets of correlation images can be used to estimate motion (e.g., XY motion at 514, Z motion as described below at 520, etc.). For example, in some embodiments, using information from non-neighboring sets can facilitate more accurate motion estimates when motion is present but very small between each set of correlation images (e.g., in some portions of a scene that may also include portions with larger motion). In such an example, motion between neighboring sets can be estimated using interpolation (e.g., as described above in connection with FIG. 4A). As another example, using information from more than two sets of correlation images can facilitate reducing noise in the motion estimates.

In some embodiments, process 500 can estimate XY speed and/or velocity for a particular portion of the scene based on the XY-motion estimate and the elapsed time. For example, process 500 can determine the speed of the XY-motion associated with a particular portion of the scene (e.g., a particular pixel(s)) based on the magnitude of the XY-motion and the time over which the motion occurs

$$( e . g . , {v}_{lat} = \frac{1}{Δ t} \sqrt{Δ {X}^{2} + Δ {Y}^{2}} ) ,$$

and can determine the velocity based on the XY-motion and the time over which the motion occurs

$$( e . g . , {v}_{lat} = \frac{( Δ X , Δ Y )}{Δ t} ) .$$

At 516, process 500 can generate a refined intensity image Iᵢ′ based on correlation images in the set of correlation images Cᵢ and the estimate of lateral motion determined at 514 using any suitable technique or combination of techniques. For example, process 500 can use interpolation to determine movement of a particular portion p of the scene (e.g., corresponding to a particular pixel or group of pixels in a reference correlation image) between correlation images based on the XY motion estimated at 514, and can use the movement information to identify which portion of each correlation image (e.g., which pixel from each correlation image in Cₖ) to use to calculate a refined intensity value for portion p (e.g., using EQ. 4)). As another example, process 500 can use techniques described above in connection with FIG. 4A.

In some embodiments, process 500 can generate a refined intensity image for another set of correlation images at 516 (e.g., a refined intensity image Iᵢ₋₁′ based on correlation images in the set of correlation images Cᵢ₋₁, for example, if such an intensity image was not previously generated).

In some embodiments, process 500 can omit 516 (e.g., when used in connection with an application that does not need or use an intensity image).

At 518, process 500 can generate a depth map Zₖ based on correlation images in the set of correlation images Cᵢ and the estimate of lateral motion determined at 514 using any suitable technique or combination of techniques. For example, process 500 can use interpolation to determine movement of a particular portion p of the scene (e.g., corresponding to a particular pixel or group of pixels in a reference correlation image) between correlation images based on the XY motion estimated at 514, and can use the movement information to identify which portion of each correlation image (e.g., which pixel from each correlation image in Cₖ) to use to calculate a depth value for portion p (e.g., using EQ. 3). As a particular example, depth values Zₖ for the k^{th} set of correlation images can be based on

$${Z}_{k} ( p ) = \frac{c}{4 π {f}_{0}} {tan}^{- 1} ( \frac{{\sum }_{n = 1}^{N} {C}_{k , n} ( {p}^{′} ) sin {ψ}_{n}}{{\sum }_{n = 1}^{N} {C}_{k , n} ( {p}^{′} ) cos {ψ}_{n}} ) ,$$

where C_{k,n}(p′) is the value for is the value for a pixel p′ in the n^{th} correlation image in Cₖ in a set of corresponding pixels that includes C_{k,1}(p), and f₀ is a frequency of the modulation function used to capture the k^{th} set of correlation images. As another example, process 500 can use techniques described above in connection with FIG. 4A.

In some embodiments, process 500 can generate a depth map for another set of correlation images at 518 (e.g., a refined intensity image Zₖ₋₁ based on correlation images in the set of correlation images Cᵢ₋₁, for example, if such a depth map was not previously generated.

In some embodiments, process 500 can omit 518 (e.g., when used in connection with an application that does not need or use information about geometry of the scene, such as 2D object detection, segmentation, etc.).

At 520, process 500 can estimate axial motion of portions of the scene based on a difference in depth between corresponding portions of the depth maps generated at 518 and estimated lateral motion at 514. For example, as described above in connection with FIG. 4A, process 500 can determine a difference in depth of a particular portion of the scene (e.g., a pixel(s) corresponding to a particular object) using depth maps generated from different sets of correlation images (e.g., ΔZ=Zₖ−Zₖ₋₁). Additionally, in some embodiments, process 500 can estimate axial speed and/or velocity for a particular portion of the scene based on the Z-motion estimate and the elapsed time. For example, process 500 can determine the speed of the Z-motion associated with a particular portion of the scene (e.g., a particular pixel(s)) based on the magnitude of the Z-motion and the time over which the motion occurs (e.g., νₐₓᵢₐₗ=ΔZ/Δt). In some embodiments, process 500 can determine the velocity of one or more portions of a scene (e.g., a particular pixel(s)) based on the lateral velocity and the axial velocity. For example, a position and velocity of an object can be used in path planning and/or collision detection process for a mobile autonomous (or semi-autonomous) device, such as a vehicle configured to perform one or more autonomy functions, an autonomous mobile robot, a drone configured to perform one or more autonomy functions, etc. As described above, although examples are generally described as using information from two neighboring sets of correlation images, using information from more than two sets of correlation images can be reduce noise in estimated axial motion.

In some embodiments, process 500 can omit 520 (e.g., when used in connection with an application that does not need or use information about axial motion in the scene).

At 522, process 500 can output values indicative of scene motion, scene geometry, and/or scene intensity for a time corresponding to a particular correlation image(s) and/or set(s) of correlation images. In some embodiments, process 500 can output any suitable value or combination of values, and the values can be formatted using any suitable technique or combination of techniques. For example, in some embodiments, process 500 can output values indicative of scene geometry as a depth map(s) (e.g., with each pixel, or groups of pixels, being associated with a particular depth, such that each visible portion of the scene is associated with a lateral position in the camera frame and a depth, such as a depth in meters to any suitable number of significant digits), such as a depth map associated with each set of correlation images (e.g., as a stream of depth maps). As another example, in some embodiments, process 500 can output values indicative of scene geometry as point cloud points (e.g., each point associated with a position in a 3D frame of reference).

As yet another example, in some embodiments, process 500 can output values indicative of scene motion as amotion vector(s) associated with each portion of the scene (e.g., with each pixel, or groups of pixels), with particular objects in the scene (e.g., if particular objects are detected, for example, using the intensity image, and/or image data from another camera, using any suitable computer vision technique or techniques). In a more particular example, the scene motion information can be formatted as a unit vector(s) (e.g., a unit vector indicating a direction of motion parallel to the XY plane, a unit vector indicating a direction of motion in three dimensions, etc.) and a speed(s). In another more particular example, the scene motion information can be formatted as a unit vector(s) having a direction and magnitude indicative of velocity in any suitable number of dimensions (e.g., in two dimensions such as lateral velocity parallel to the XY plane, or three dimensions indicating lateral and axial velocity). As yet another more particular example, the scene motion information can be formatted as the amount of motion in each dimension (e.g., ΔX, ΔY, and/or ΔZ). As still another more particular example, the scene motion information can be formatted as a speed in each direction (e.g., νₓ, ν_{y}, and/or ν_{z}).

As still another example, in some embodiments, process 500 can output values indicative of scene intensity associated with each portion of the scene. For example, process 500 can output a refined intensity image (e.g., Iₖ′ and/or Iₖ₋₁′) generated at 516.

FIG. 6 shows an example of a process 600 for generating a set of correlation images using an indirect time-of-flight imaging system in accordance with some embodiments of the disclosed subject matter.

As shown in FIG. 6, process 600 can start at 602 with an index n equal to 1. Note that index n is used herein for convenience, and such an index can be omitted in some implementations of the disclosed subject matter, and/or can be initiated at a different value.

At 604, process 600 can cause a light source to emit light using one or more modulation functions. For example, in some embodiments, process 600 can cause the light source (e.g., light source 102) to emit modulated light toward the scene (e.g., scene 120) using a modulation function corresponding to the n^{th} measurement (e.g., Mₙ(t)) of N measurements that are to be captured. In some embodiments, the modulation function corresponding to each measurement period can be the same. For example, the modulation function associated with each measurement of N measurements can be the same (e.g., a unipolar sinusoid, a bipolar sinusoid, a square wave, etc.). In such an example, the light source (e.g., light source 120) can be configured to continuously emit the same pattern. Note that different sets of correlation images can included different numbers of measurements. For example, the number of measurements for a k^{th} set of correlation images Cₖ can be designated as Nₖ, and the number of measurements for a (k+1)^{th} set of correlation images Cₖ₊₁ can be designated as Nₖ₊₁. In some embodiments, the number of measurements is the same for all sets of correlation images.

At 606, process 600 can cause light received from the scene to be captured during measurement period n using a demodulation signal corresponding to the n^{th} measurement period. For example, process 600 can cause light reflected from the scene to be captured during measurement period n using an image sensor (e.g., image sensor 104) modulated using a demodulation signal corresponding to the n^{th} measurement period. In some embodiments, the demodulation function corresponding to each measurement period can the same (e.g., can have the same profile) or one or more of the demodulation functions can be different (e.g., can have a different profile). For example, as described above in connection with FIG. 3, a single demodulation function D(t) can be used, and the phase of the modulation function can be shifted for each measurement period. As another example, different demodulation functions D(t) can be used for different measurement periods (e.g., each measurement period can be associated with a different modulation function Dₙ(t)).

At 608, process 600 can generate and/or output values indicative of the intensity of light captured at various different portions of the image sensor (e.g., at each pixel). In some embodiments, the values generated at 608 can be values of a correlation image (e.g., as described above in connection with FIGS. 3 and 4A), such as a correlation image C_{k,n} for the n^{th} measurement period of the k^{th} set of correlation images Cₖ. In some embodiments, process 600 can output the values to any suitable location(s) and/or using any suitable communication link (e.g., via an I/O port(s), via a serial communication link, etc.). For example, process 600 can cause the value(s) to be recorded in memory, a buffer (e.g., a first-in-first-out buffer, a frame buffer, etc., and/or any other suitable type of buffer), etc. In such an example, a process being used to determine information about the scene from the output of process 600 at 608 can access and/or use the information output at 608 (e.g., as described above in connection with process 500 of FIG. 5). As another example, process 600 can cause the value(s) to be streamed to another processor and/or computing device. In a more particular example, at least a portion of process 600 can be executed by a first processor(s) and information generated using process 600 can provided to a second processor, which can execute at least a portion of a process that uses the information (e.g., to generate scene motion, geometry, and/or intensity information). In such an example, the first processor(s) and second processor(s) may or may not be locate within the same device (e.g., within the same housing, on a common printed circuit board, etc.).

At 610, process 600 can determine whether a sufficient number of measurements have been generated (e.g., whether N or Nₖ measurements have been generated). If process 600 determines that more measurements are to be generated (“NO” at 610), process 600 can return to 604. For example, in the particular example of FIG. 6, if index n is less than N (or Nₖ), process 600 can determine that more measurements are to be taken (“NO” at 610), and process 600 can move to 612. At 612, process 600 can increment index n by one, and process 600 can return to 604. Note that this is an example, and any suitable technique can be used to determine whether to generate and/or output additional measurements (e.g., at 604 to 608).

Otherwise, if process 600 determines that a sufficient number of measurements have been generated (“YES” at 610), process 600 can move to 614. For example, in the particular example of FIG. 6, if index n is equal to (or greater than) N (or Nₖ), process 600 can determine that a sufficient number of measurements have been taken (“YES” at 610), and process 600 can move to 614, and end generating measurements for the current set of correlation images.

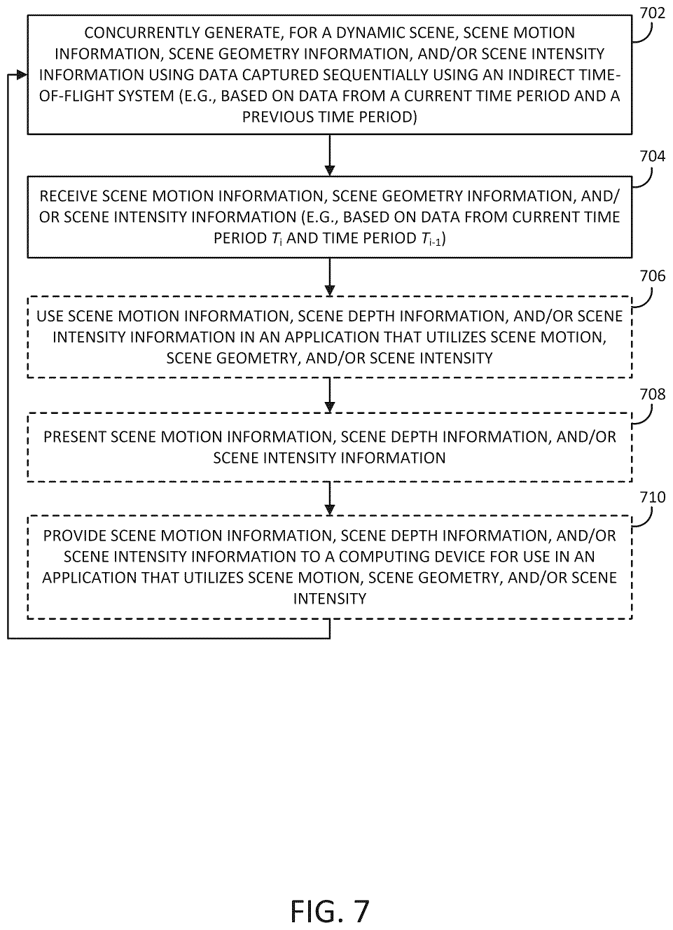

FIG. 7 shows an example of a process 700 for generating and using motion, depth, and/or intensity estimates for a scene from a stream of data captured sequentially from a in accordance with some embodiments of the disclosed subject matter.

At 702, process 700 can generate, for a dynamic scene, scene motion information, scene geometry information, and/or scene intensity information using data captured sequentially using an I-ToF system (e.g., based on data from a current time period, such as a time period during which a set of correlation images Cₖ were captured, and data from another time period, such as a previous time period during which a set of correlation images Cₖ₋₁ were captured).

In some embodiments, process 700 can generate the scene motion information, scene geometry information, and/or scene intensity information using any suitable techniques, such as techniques described above in connection with process 500 of FIG. 5.

In some embodiments, scene motion information, scene geometry information, and/or scene intensity information can be generated, at 702, by a processor(s) of an imaging device that captured the data used to generate the information (e.g., processor 108, circuitry implemented in image sensor 104, etc.). Additionally or alternatively, in some embodiments, scene motion information, scene geometry information, and/or scene intensity information can be generated, at 702, by another processor (e.g., a processor associated with a computing device other than system 100). For example, a device executing process 700 can receive correlation images (e.g., as a stream of correlation images) from an image sensor (e.g., image sensor 104) and/or camera (e.g., a camera incorporating image sensor 104), and can use the correlation images to generate the scene motion information, scene geometry information, and/or scene intensity information at 702.

At 704, process 700 can receive scene motion information, scene geometry information, and/or scene intensity information generated at 702. In some embodiments, the scene information received at 704 can be received from any suitable device and/or location. For example, if the entirety of process 700 is being executed by a device that generated the information at 702, process 700 can receive the information directly (e.g., on the same processor that generated the information at 702, for example as part of a data processing pipeline that uses and/or outputs the data for use by another device), or can receive the information from a processor (or portion of a processor, such as a core) that generated the information at 702. In a more particular example, if the device that generated the information at 702 is also going to use and/or output the information (e.g., to present to a user, to perform one or more computer vision tasks, etc.), the information may be used and/or output (e.g., at one or more of 706 to 710) by a different processor (or portion of a processor) than the processor (or portion of a processor) that generated the data at 702.

As another example, if at least a portion of process 700 is being executed by a device that is different than the device that generated the information at 702, process 700 can receive the from the device that generated the information at 702 (e.g., via a communication link and/or communication network). In a more particular example, if the device that generated the information at 702 is different than the device that is going to use and/or output the information (e.g., to present to a user, to perform one or more computer vision tasks, etc.), the information may be received at 704, and used and/or output (e.g., at one or more of 706 to 710) by the receiving device.

At 706, process 700 can use scene motion information, scene geometry information, and/or scene intensity information to perform a task and/or in an application that utilizes scene motion, scene geometry, and/or scene intensity information. In some embodiments, process 700 can use the scene motion information, scene geometry information, and/or scene intensity information to perform any suitable a task and/or in any suitable application(s).

For example, many computer vision tasks can use one or more of scene motion information, scene geometry information, and/or scene intensity information, such as object detection and/or recognition tasks, image segmentation tasks, autonomous navigation tasks (e.g., path planning, collision avoidance, etc., which can be performed for a variety of mobile autonomous or semi-autonomous devices, etc.), autonomous control tasks (e.g., to control a task(s) performed by an autonomous robot based on characteristics of the environment), user interface tasks (e.g., presenting and/or controlling a user interface for a mixed reality device, such as an augmented reality or virtual reality head mounted display that adjusts what is presented based on the environment), modeling an environment(s), mapping, etc. Some examples can use only one of the types of information (e.g., only scene geometry, scene motion, or scene intensity), and other examples can use multiple types of information (e.g., a combination of scene geometry, scene motion, and/or scene intensity).

In some process 700 can omit 706 (e.g., when information received at 704 is presented and/or provided to another device, but not used in connection with an application executed by the same device that is executing process 700).

At 708, process 700 can present scene motion information, scene geometry information, and/or scene intensity information, and/or cause such information to be presented. In some embodiments, process 700 can present the scene motion information, scene geometry information, and/or scene intensity information in any suitable format and/or using any suitable technique(s). For example, process 700 can present scene motion information, scene geometry information, and/or scene intensity information using a display (e.g., display 118). As another example, process 700 can present scene motion information, scene geometry information, and/or scene intensity information in a format similar to formats shown in one or more of FIGS. 2, 3, 4B, and/or 9-13. Additionally or alternatively, process 700 can present scene motion information, scene geometry information, and/or scene intensity information in any other suitable format.

In some embodiments, process 700 can present scene motion information, scene geometry information, and/or scene intensity information in connection with other information (e.g., a refined intensity image generated at 702, an image generated from a conventional digital camera, label information indicating information about an object in the scene such as a speed, velocity, distance, and/or any other suitable information that can be derived from the information received at 704, etc.).

In some process 700 can omit 708 (e.g., when information received at 704 is used and/or provided to another device, but not presented by the same device that is executing process 700).

At 710, process 700 can provide scene motion information, scene geometry information, and/or scene intensity information to a computing device for use in performing a task and/or in an application that utilizes scene motion, scene geometry, and/or scene intensity information. In some embodiments, process 700 can provide information generated at 702 and/or received at 704 to another device, such as a processor configured to analyze and/or use scene motion, scene geometry, and/or scene intensity information to perform a task (e.g., such as tasks described above in connection with 706). For example, process 700 can provide information generated at 702 and/or received at 704 to a controller of a vehicle (e.g., an autonomous or semi-autonomous vehicle), a controller of a robot (e.g., an autonomous or semi-autonomous robot configured to perform one or more tasks), a controller of a mixed reality presentation device, etc.

In some process 700 can omit 710 (e.g., when information received at 704 is used and/or presented, but not provided to another device).

In some embodiments, process 700 can return to 702, and can continue to generate, receive, use, present, and/or output scene motion, scene geometry, and/or scene intensity information.

FIG. 8 shows an example of standard deviations of velocity measurements under various conditions using Doppler time-of-flight and indirect time-of-flight techniques implemented in accordance with some embodiments of the disclosed subject matter. In FIG. 8 velocity standard deviations in velocity estimates calculated using Doppler ToF (σ_{ν}_{_{Δf}}) and using mechanisms described herein (sometimes referred to as depth difference) (σ_{ν}_{_{Z}}) are compared. Doppler ToF shows about 40 times higher standard deviation in the given practical conditions, and its estimation becomes very unreliable at certain modulation frequencies and depth values.

Doppler ToF imaging is another technique for estimating axial motion using ToF principles (e.g., as described in Heide et al., “Doppler time-of-flight imaging,” ACM Transactions on Graphics (ToG) 34(4), 1-11 (2015)), which attempts to estimate Z-motion based on the Doppler effect. Given a scene with an axial velocity ν, the emitted light undergoes a Doppler frequency shift when reflected from the scene. If the modulation frequency of the light signal is f₀, the frequency of the signal received at the sensor is f₀+Δf, where

$$Δ f = \frac{2 v}{c} {f}_{0} .$$

Although Doppler ToF allows for instantaneous Z-motion estimation without measuring two depth values, it is challenging to measure Δf (thus axial velocity ν) accurately under Poisson noise since Δf is negligibly small, compared to f₀ in practical conditions. EQS. (9) and (10) are the theoretical standard deviations of the estimated axial velocity by depth difference (σ_{ν}_{_{Z}}) (e.g., using techniques described herein) and Doppler ToF (σ_{ν}_{_{f}}), respectively:

$${σ}_{{v}_{Δ Z}} = \frac{c}{\sqrt{2} π {f}_{0} \sqrt{T} Δ t} \frac{\sqrt{{e}_{s} + {e}_{a}}}{{e}_{s}} \qquad ( 9 )$$

$$and$$

$${σ}_{{v}_{Δ f}} = \frac{2 π c}{{f}_{0} \sqrt{T}} \frac{\sqrt{{e}_{s} + {e}_{a}}}{{e}_{s}} \frac{\sqrt{\frac{1}{{( Δ f - \frac{1}{T} )}^{2}} + \frac{1}{Δ {f}^{2}}}}{{( \frac{1}{Δ f - \frac{1}{T}} - \frac{1}{Δ f} )}^{2}} \frac{1}{\vert sin ( 2 πΔ fT - ϕ ) + sin ϕ \vert} , \qquad ( 10 )$$

where

$$ϕ = \frac{4 π {f}_{0} Z}{c} .$$

Appendix A includes derivations of EQS. (9) and (10).

The graphs in FIG. 8 show σ_{ν}_{_{Z}} and σ_{ν}_{_{f}} over as a function of the source strength eₛ, axial velocity ν, modulation frequency f₀, and scene depth Z, respectively. When one of these parameters was varied, the other parameters were fixed as eₛ=5×10⁷ photo-electrons per second (e⁻/s), ν=5 meters/second (m/s), f₀=10 megahertz (MHz), T=5 milliseconds (ms), Δt=40 ms, and Z=1 m. Simulation results are also included, which are consistent with the results based on EQS. (9) and (10). Note that velocity estimation was simulated from depth difference and Doppler ToF under Poisson noise.

$${σ}_{{v}_{Δ z}} and {σ}_{{v}_{Δ f}}$$

were computed from 1,000 repetitions. Under the given conditions,

$${σ}_{{v}_{Δ f}}$$

is ˜40 times higher than σ_{ν}_{_{ΔZ}}. Axial motion estimates from Doppler ToF have large noise when the term |sin(2πΔfT−ϕ)+sin ϕ| in EQ. (10) converges to 0 (shown as peaks at certain f₀ and Z values in FIG. 8 and as horizontal error lines in FIG. 9). Estimating the Z-motion from the depth difference can also be challenging when the depth estimates are noisy, and can be mitigated using techniques described herein, such as multi-frequency coding techniques and/or burst imaging techniques. Appendix A includes additional analysis, comparing the number of measurements between the mechanisms described herein and Doppler ToF.

FIG. 9 shows an example of axial motion estimates generated under various conditions using Doppler time-of-flight techniques and indirect time-of-flight techniques implemented in accordance with some embodiments of the disclosed subject matter. In FIG. 9, a dynamic scene is depicted with its ground-truth Z-motion, and estimated Z-motions generated by Doppler ToF and using mechanisms described herein (including multi-frequency and burst techniques described herein) are also included. As shown in FIG. 9, the Doppler ToF techniques was not capable of estimate small Z-motions (e.g., anything smaller than ˜6 m/s) accurately since the corresponding Doppler frequency shifts (<1 Hz) are negligibly small as compared to the modulation frequency (in the MHz range). In contrast, axial motion estimates generated using mechanisms described herein were able resolve even the relatively small Z-motions in the scene reliably.

As described above, FIG. 9 compares Z-motion estimation performance between results generated using techniques described above in connection with FIGS. 1 to 4A, and Doppler ToF, which measures instantaneous axial motion based on the Doppler effect. For the Doppler ToF estimates, a binning-based non-local means denoiser was also used to increase the SNR (e.g., as described in Heide et al., “Doppler time-of-flight imaging,” referenced above). As shown in FIG. 9, Doppler ToF cannot robustly estimate the axial motions of approximately 20 km/h (˜6 m/s), as the corresponding Doppler shift (<1 Hz) is negligibly small compared to the modulation frequency (in the MHz range).

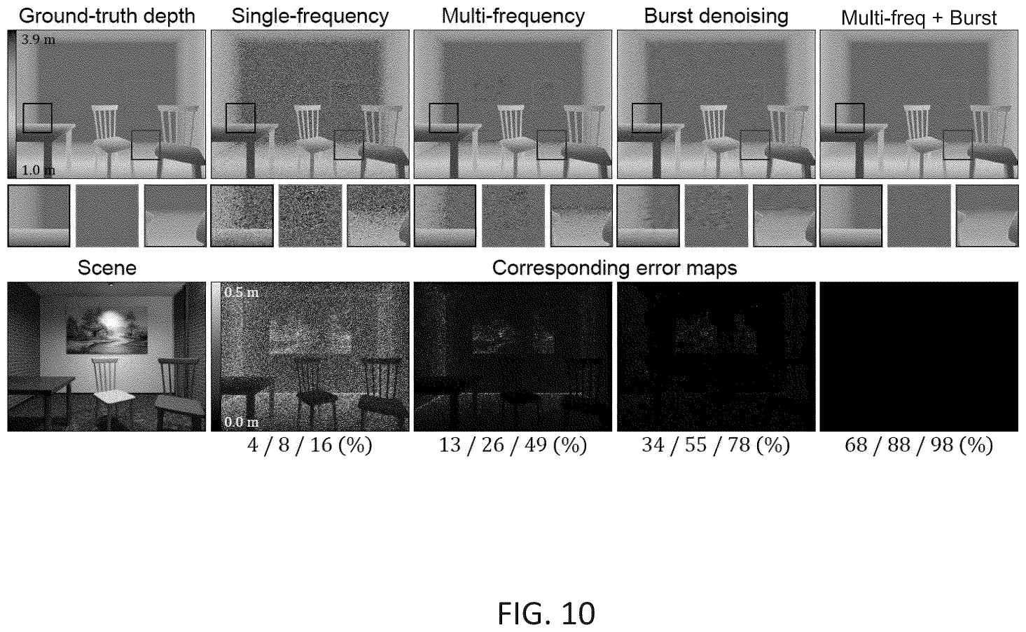

FIG. 10 shows an example of a static scene, with depth estimates generated using various indirect time-of-flight techniques, including single-frequency coding, multi-frequency coding, burst denoising from correlation images, and multi-frequency coding and burst imaging techniques. As shown in FIG. 10, although multi-frequency coding achieves lower depth errors than single-frequency coding, it fails to decode the correct depths under extremely low SNR conditions. For example, it is generally difficult to obtain accurate depth values for distant objects, such as the rear wall, and objects with fine textures, such as the painting on the rear wall which is both relatively distinct and has a fine texture. Additionally, the simulated environment in FIG. 10 was simulated with more challenging lighting conditions (e.g., lower signal strength relative to the higher ambient light level). The performance of multi-frequency coding can be improved when combined with burst denoising, which reduces the depth noise in a complementary way. The three numbers underneath each depth map show the percent fraction of inlier pixels that lie within 0.5, 1, and 2% of the true depths.

As described above, multi-frequency schemes and burst denoising can improve depth estimation accuracy in complementary ways. Multi-frequency schemes can increase the modulation frequency used for I-ToF, and burst imaging (sometimes referred to as burst denoising) extends the integration time computationally. Using both a multi-frequency scheme and burst imaging techniques can considerably improve the depth estimation performance. As shown in FIG. 10; when integrated with the multi-frequency scheme, burst denoising can improve the quality of interim depth estimates and reduce decoding errors in the final depth estimates compared to using cither technique alone. Appendix A includes additional description related to using multi-frequency coding and burst imaging techniques, both separately and together.

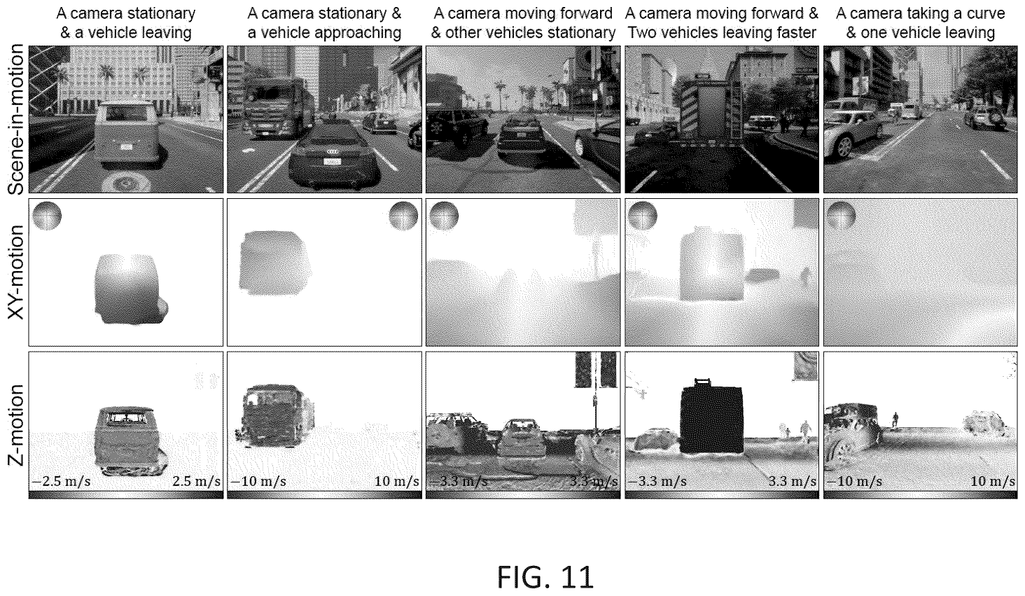

FIG. 11 shows an example of motion estimates generated from spatial gradients based on sets of correlation images of various dynamic scenes in accordance with some embodiments of the disclosed subject matter. Mechanisms described herein can be used to estimate dense and high-quality 3D motions for various dynamic scenes. Several scenes and motion scenarios are included in FIG. 11, with the motion scenarios corresponding to the our XY- and Z-motion estimates shown in FIG. 11

The various motion scenarios were in FIG. 11 were simulated for an I-ToF camera attached to a moving car using the CARLA simulator. The XY-motion and Z-motion results in FIG. 11 are 3D motion estimation results of the various dynamic scenes using mechanisms described herein (including burst imaging techniques described below). As shown in FIG. 11, reliable estimates of 3D motions across different motion scenarios were generated using mechanisms described herein. The XY-motion was estimated from the gradient of the I-ToF intensity image using the RAFT optical flow technique (e.g., as described in Teed, et al., “Raft: Recurrent all-pairs field transforms for optical flow.” in: Computer Vision-ECCV 2020: 16th European Conference, Glasgow, UK, Aug. 23-28, 2020, Proceedings, Part II 16. pp. 402-419. Springer (2020)) in both the simulation and experimental results included herein. However, many other optical flow techniques can be used, including any optical flow technique that achieves results that are at least comparable to RAFT.

FIGS. 12 and 13 include results generated using a hardware prototype that was implemented in accordance with some embodiments of the disclosed subject matter. The hardware prototype included a KeaB I-ToF camera (available from Chronoptics, headquartered in Hamilton, New Zealand) with a resolution of 240×320 pixels, which provides access to raw correlation images. Two modulation frequencies were used, 40 MHz and 50 MHz, to capture two neighboring correlation image sets. The integration time was set to 2 ms for indoor and 3 ms for outdoor scenes, and 4 and 6 correlation images were used for each set for indoor and outdoor scenes, respectively.

FIG. 12 shows examples of intensity and depth estimates for two scenes generated using conventional indirect time-of-flight techniques with short and long integration times to a depth and intensity estimates generated using indirect time-of-flight techniques implemented in accordance with some embodiments of the disclosed subject matter. In FIG. 12, panel (a) includes ground truth intensity and depths for a dynamic indoor scene, and estimated scene intensity and depths using conventional I-ToF techniques (with a short and long integration time, respectively), and using mechanisms described herein, and panel (b) includes ground truth intensity and depths for a dynamic outdoor scene, and estimated scene intensity and depths using conventional I-ToF techniques (with a short and long integration time, respectively), and using mechanisms described herein (including burst imaging techniques described below). As shown in FIG. 12, the 3D geometry and intensity estimates using conventional I-ToF techniques with short and long integration times suffer from low SNR and motion artifacts in both the indoor and outdoor scenes, while the estimates generated using mechanisms described herein recovered high-quality and motion artifact-free estimates.

The conventional results were generated from correlation images captured with short integration times (indoor: 2 ms, outdoor: 3 ms) and long integration times (indoor: 18 ms, outdoor: 27 ms). The ground-truth data was obtained by averaging 1,000 correlation images captured with the short integration times while the scene was static. As shown in FIG. 12, the estimates obtained with short integration times exhibit low SNR, while those obtained with long integration times suffer from motion artifacts. In contrast, the estimates obtained using mechanisms described herein recovered high-SNR 3D geometry and intensity, free from motion artifacts, for both indoor and outdoor dynamic scenes.

FIG. 13 shows examples of intensity and motion estimates for various indoor and outdoor scenes generated using indirect time-of-flight techniques implemented in accordance with some embodiments of the disclosed subject matter. As shown in FIG. 13, the hardware prototype implemented using mechanisms described herein was able to recover 3D motions reliably for dynamic indoor and outdoor scenes. Both local and global motions were recovered under challenging conditions such as a low scene albedo (e.g., in the leaving black tire scene) and a thin object (e.g., intricate geometry in the rotating stick scene). Appendix A includes additional results.

### Further Examples Having a Variety of Features

Implementation examples are described in the following numbered clauses:
1. A method for estimating depths of a dynamic scene, the method comprising: causing a light source to emit modulated light toward the scene, with modulation based on a first signal from a signal generator configured to output at least the first signal corresponding to a modulation function; causing an image sensor to generate, during a first period of time, a first set of correlation images comprising a first plurality of correlation images, wherein the image sensor comprises a plurality of pixels, and wherein each correlation image of the first plurality of correlation images comprises a plurality of pixel values, and each pixel value of the plurality of pixel values is based on a correlation between modulated light received from a portion of the scene at that pixel and a demodulation function of a plurality of demodulation functions; generating a first intensity image based on the first set of correlation images, wherein the first intensity image comprises a first plurality of intensity values; causing the image sensor to generate, during a second period of time, a second set of correlation images comprising a second plurality of correlation images; generating a second intensity image based on the second set of correlation images, wherein the second intensity image comprises a second plurality of intensity values; calculating a first model of the first intensity image based on the first plurality of intensity values; calculating a second model of the second intensity image based on the second plurality of intensity values; determining estimated lateral motion in the scene between the first period of time and the second period of time based on the first model and the second model; and determining a set of depth estimates for the scene based on the first plurality of correlation images and the estimated lateral motion in the scene, wherein the set of depth estimates comprises, for each of the plurality of pixels, a depth estimate for a corresponding portion of the scene during the first period of time.
2. A method for estimating depths of a dynamic scene using indirect time-of-flight (I-ToF), the method comprising: receiving a first set of correlation images generated by an I-ToF camera during a first period of time, wherein the I-ToF camera comprises: an image sensor comprising a plurality of pixels and a light source configured to emit modulated light, and wherein the first set of correlation images optionally comprises a first plurality of correlation images, each correlation image of the first plurality of correlation images comprising a plurality of pixel values, each pixel value of the plurality of pixel values is based on a correlation between modulated light received from a portion of the scene at that pixel and a demodulation function of a plurality of demodulation functions; receiving a second set of correlation images generated by the I-ToF camera during a second period of time, optionally comprising a second plurality of correlation images; generating a first blurred intensity image using the first set of correlation images; generating a second blurred intensity image using the second set of correlation images; determining estimated lateral motion in the scene between the first period of time and the second period of time based on a distribution of intensity values in the first blurred image and a distribution of intensity values in the second blurred image; determining a first depth map for the scene based on the first set of correlation images and the estimated lateral motion in the scene; and determining a second depth map for the scene based on the second set of correlation images and the estimated lateral motion in the scene.
3. The method of clause 2, further comprising: generating, using the I-ToF camera, the first set of correlation images; and generating, using the I-ToF camera, the second set of correlation images.
4. The method of any one of clauses 2 or 3, further comprising: generating a first refined intensity image using the first set of correlation images and the estimated lateral motion in the scene; and generating a second refined intensity image using the second set of correlation images and the estimated lateral motion in the scene.
5. The method of any one of clauses 2 to 4, further comprising: determining estimated axial motion in the scene between the first period of time and the second period of time based on differences between depth values in the first depth map and depth values in the second depth map identified using the estimated lateral motion in the scene.
6. The method of any one of clauses 2 to 5, further comprising: calculating a first spatial gradient of the first blurred intensity image; calculating a second spatial gradient of the second blurred intensity image; and identifying correlations between the first spatial gradient and the second spatial gradient using an optical flow algorithm; and determining the estimated lateral motion in the scene between the first period of time and the second period of time using the correlations.
7. The method of any one of clauses 1 to 6, further comprising: generating a refined intensity image based on the first plurality of correlation images and the estimated lateral motion in the scene.
8. The method of any one of clauses 1 or 7, further comprising: determining a second set of depth estimates for the scene based on the second plurality of correlation images and the estimated lateral motion in the scene, wherein the second set of depth estimates comprises, for each of the plurality of pixels, a depth estimate for a corresponding portion of the scene during the second period of time; and determining an estimate of axial motion for at least a portion of the scene based on the first set of depth estimates, the second set of depth estimates, and the estimated lateral motion in the scene.
9. The method of clause 8, further comprising: identifying, for each of the plurality of pixels represented in the first set of depth estimates, a corresponding pixel represented in the second set of depth estimates using the estimated lateral motion for the pixel represented in the first set of depth estimates; and estimating, for each of the plurality of pixels represented in the first set of depth estimates, the axial motion for a portion of the scene corresponding to that pixel based on a difference between the depth estimate for the pixel represented in the first set of depth estimates and the depth estimate for the corresponding pixel represented in the second set of depth estimates.
10. The method of any one of clauses 8 or 9, further comprising: causing the light source to emit modulated light toward the scene with modulation based on a second signal, wherein the first signal is a periodic signal with a first fundamental frequency f₁, and the second signal is a periodic signal with a fundamental second frequency f₂ that is different than the first fundamental frequency, and wherein each correlation image of the second plurality of correlation images comprises a second plurality of pixel values, and each pixel value of the second plurality of pixel values is based on a correlation between modulated light of the second fundamental frequency received from a portion of the scene at that pixel and a demodulation function of a second plurality of demodulation functions.
11. The method of clause 10, wherein a maximum unambiguous measurable depth range measurable using a modulation function with the first fundamental frequency f₁ is Zₘₐₓ(f₁), and a maximum unambiguous measurable depth range measurable using a modulation function with the second fundamental frequency f₂ is Zₘₐₓ(f₂), such that if the scene has a maximum depth Zₘₐₓ′>Zₘₐₓ(f₁)>Zₘₐₓ(f₂), depth estimates in an initial first set of depth estimates based on the first set of correlation images are ambiguous, and depth estimates in an initial second set of depth estimates based on the first set of correlation images are ambiguous, and wherein the method further comprises: decoding the set of depth estimates and the second set of depth estimates using the initial first set of depth estimates and the initial second set of depth estimates, such that the set of depth estimates and the second set of depth estimates include unambiguous depth estimates.
12. The method of any one of clauses 1 to 11, wherein the plurality of demodulation functions comprises a plurality of versions of the modulation function, each having a different phase shift.
13. The method of any one of clauses 1 to 12, wherein the modulation function is a unipolar sinusoidal modulation function.
14. The method of any one of clauses 1 to 13, wherein the first model comprises a spatial gradient of the first intensity image, the second model comprises a spatial gradient of the second intensity image, and wherein the method further comprises: determining the estimated lateral motion in the scene based on correlations between the first model and the second model.
15. The method of any one of clauses 1 to 14, further comprising: generating a first set of burst correlation images based on a plurality of sets of correlation images generated using the plurality of demodulation functions, a plurality of sets of correlation images includes the first set of correlation images, wherein pixel values of a first burst correlation image in the first set of burst correlation images are based pixel values of correlation images in the plurality of sets of correlation images generated using the same demodulation function and correlations between the correlation images in the plurality of sets of correlation images generated using the same demodulation function; generating a second set of burst correlation images based on at least the second set of correlation images; generating the first intensity image using the first set of burst correlation images; and generating the second intensity image using the second set of burst correlation images.
16. The method of clause 15, wherein the first signal is a periodic signal with a first fundamental frequency f₁, and the plurality of sets of correlation images were generated based on the first signal, and wherein the second set of burst correlation images are based on a second plurality of sets generated based on a second signal that is a periodic signal with a second fundamental frequency f₂≠f₁.
17. The method of any one of clauses 1 to 16, further comprising: identifying a set of corresponding pixels in the first set of correlation images based on the estimated lateral motion; and determining a depth estimate for a portion of the scene corresponding to the set of corresponding pixels based on pixel values of the set of corresponding pixels.
18. The method of clause 17, further comprising: generating the first intensity image based on the first set of correlation images according to the following expression:

$${I}_{1} ( p ) = \frac{1}{N} \sqrt{{( {\sum }_{n = 1}^{N} {C}_{1 , n} ( p ) cos {ψ}_{n} )}^{2} + {( {\sum }_{n = 1}^{N} {C}_{1 , n} ( p ) sin {ψ}_{n} )}^{2}}$$

where I₁ is the first intensity image, I₁(p) is the intensity value of a pixel p in the first intensity image, C₁ is the first set of correlation images, C_{1,n}(p) is the value for pixel p in the n^{th} correlation image in C₁, N is a number of correlation images in C₁, and ψₙ is a phase shift of the demodulation function used to generate the n^{th} correlation image, such that the first intensity image is blurred based on motion in the scene; and determining the set of depth estimates for the scene according to the following expression:

$${Z}_{1} ( p ) = \frac{c}{4 π {f}_{1}} {tan}^{- 1} ( \frac{{\sum }_{n = 1}^{N} {C}_{1 , n} ( {p}^{′} ) sin {ψ}_{n}}{{\sum }_{n = 1}^{N} {C}_{1 , n} ( {p}^{′} ) cos {ψ}_{n}} )$$

where Z₁ is the set of depth estimates for the scene based on C₁, Z₁(p) is the depth estimate of pixel p in the first intensity image, C_{1,n}(p′) is the value for a pixel p′ in the n^{th} correlation image in C₁ in the set of corresponding pixels that includes C_{1,1}(p), and f₁ is a fundamental frequency of the first signal.
19. A system comprising: one or more processors configured to: perform a method of any one of clauses 1 to 18.
20. A non-transitory computer-readable medium storing computer-executable code, comprising code for causing a computer to cause a processor to: perform a method of any of one of clauses 1 to 18.

In some embodiments, any suitable computer readable media can be used for storing instructions for performing the functions and/or processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as RAM, Flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, or any suitable media that is fleeting and devoid of any semblance of permanence during transmission, and/or any suitable intangible media.

It should be noted that, as used herein, the term mechanism can encompass hardware, software, firmware, or any suitable combination thereof

It should be understood that above-described steps of the processes of FIGS. 5 to 7 can be executed or performed in any suitable order or sequence not limited to the order and sequence shown and described in the figures. Also, some of the above steps of the processes of FIGS. 5 to 7 can be executed or performed substantially simultaneously where appropriate or in parallel to reduce latency and processing times.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A system for estimating depths of a dynamic scene, the system comprising:
a light source;
an image sensor comprising a plurality of pixels;
a signal generator configured to output at least:
a first signal corresponding to a modulation function; and
one or more processors configured to:
cause the light source to emit modulated light toward the scene, with modulation based on the first signal;
cause the image sensor to generate, during a first period of time, a first set of correlation images comprising a first plurality of correlation images,
wherein each correlation image of the first plurality of correlation images comprises a plurality of pixel values, and each pixel value of the plurality of pixel values is based on a correlation between modulated light received from a portion of the scene at that pixel and a demodulation function of a plurality of demodulation functions;
generate a first intensity image based on the first set of correlation images,
wherein the first intensity image comprises a first plurality of intensity values;
cause the image sensor to generate, during a second period of time, a second set of correlation images comprising a second plurality of correlation images;
generate a second intensity image based on the second set of correlation images,
wherein the second intensity image comprises a second plurality of intensity values;
calculate a first model of the first intensity image based on the first plurality of intensity values;
calculate a second model of the second intensity image based on the second plurality of intensity values;
determine estimated lateral motion in the scene between the first period of time and the second period of time based on the first model and the second model; and
determine a set of depth estimates for the scene based on the first plurality of correlation images and the estimated lateral motion in the scene,
wherein the set of depth estimates comprises, for each of the plurality of pixels, a depth estimate for a corresponding portion of the scene during the first period of time.

2. The system of claim 1, wherein the one or more processors are further configured to:
generate a refined intensity image based on the first plurality of correlation images and the estimated lateral motion in the scene,
wherein a signal-to-noise ratio of the refined intensity image is higher than a signal-to-noise ratio of the intensity image.

3. The system of claim 1, wherein the one or more processors are further configured to:
determine a second set of depth estimates for the scene based on the second plurality of correlation images and the estimated lateral motion in the scene,
wherein the second set of depth estimates comprises, for each of the plurality of pixels, a depth estimate for a corresponding portion of the scene during the second period of time; and
determine an estimate of axial motion for at least a portion of the scene based on the first set of depth estimates, the second set of depth estimates, and the estimated lateral motion in the scene.

4. The system of claim 3, wherein the one or more processors are further configured to:
identify, for each of the plurality of pixels represented in the first set of depth estimates, a corresponding pixel represented in the second set of depth estimates using the estimated lateral motion for the pixel represented in the first set of depth estimates; and
estimate, for each of the plurality of pixels represented in the first set of depth estimates, the axial motion for a portion of the scene corresponding to that pixel based on a difference between the depth estimate for the pixel represented in the first set of depth estimates and the depth estimate for the corresponding pixel represented in the second set of depth estimates.

5. The system of claim 3, wherein the one or more processors are further configured to:
cause the light source to emit modulated light toward the scene with modulation based on a second signal,
wherein the first signal is a periodic signal with a first fundamental frequency f₁, and the second signal is a periodic signal with a second fundamental frequency f₂ that is different than the first fundamental frequency, and
wherein each correlation image of the second plurality of correlation images comprises a second plurality of pixel values, and each pixel value of the second plurality of pixel values is based on a correlation between modulated light of the second fundamental frequency received from a portion of the scene at that pixel and a demodulation function of a second plurality of demodulation functions.

6. The system of claim 5, wherein a maximum unambiguous measurable depth range measurable using a modulation function with the first fundamental frequency f₁ is Zₘₐₓ(f₁), and a maximum unambiguous measurable depth range measurable using a modulation function with the second fundamental frequency f₂ is Zₘₐₓ(f₂), such that if the scene has a maximum depth Zₘₐₓ′>Zₘₐₓ(f₁)>Zₘₐₓ(f₂), depth estimates in an initial first set of depth estimates based on the first set of correlation images are ambiguous, and depth estimates in an initial second set of depth estimates based on the first set of correlation images are ambiguous, and
wherein the one or more processors are further configured to:
decode the set of depth estimates and the second set of depth estimates using the initial first set of depth estimates and the initial second set of depth estimates, such that the set of depth estimates and the second set of depth estimates include unambiguous depth estimates.

7. The system of claim 1, wherein the plurality of demodulation functions comprises a plurality of versions of the modulation function, each having a different phase shift.

8. The system of claim 1, wherein the modulation function is a unipolar sinusoidal modulation function.

9. The system of claim 1, wherein the first model comprises a spatial gradient of the first intensity image, the second model comprises a spatial gradient of the second intensity image, and
wherein the one or more processors are further configured to:
determine the estimated lateral motion in the scene based on correlations between the first model and the second model.

10. The system of claim 1, wherein the one or more processors are further configured to:
generate a first set of burst correlation images based on a plurality of sets of correlation images generated using the plurality of demodulation functions, a plurality of sets of correlation images includes the first set of correlation images,
wherein pixel values of a first burst correlation image in the first set of burst correlation images are based pixel values of correlation images in the plurality of sets of correlation images generated using the same demodulation function and correlations between the correlation images in the plurality of sets of correlation images generated using the same demodulation function;
generate a second set of burst correlation images based on at least the second set of correlation images;
generate the first intensity image using the first set of burst correlation images; and
generate the second intensity image using the second set of burst correlation images.

11. The system of claim 10, wherein the first signal is a periodic signal with a first fundamental frequency f₁, and the plurality of sets of correlation images were generated based on the first signal, and
wherein the second set of burst correlation images are based on a second plurality of sets generated based on a second signal that is a periodic signal with a second fundamental frequency f₂≠f₁.

12. The system of claim 1, wherein the one or more processors are further configured to:
identify a set of corresponding pixels in the first set of correlation images based on the estimated lateral motion; and
determine a depth estimate for a portion of the scene corresponding to the set of corresponding pixels based on pixel values of the set of corresponding pixels.

13. The system of claim 12, wherein the one or more processors are further configured to:
generate the first intensity image based on the first set of correlation images according to the following expression:
$${I}_{1} ( p ) = \frac{1}{N} \sqrt{{( {\sum }_{n = 1}^{N} {C}_{1 , n} ( p ) cos {ψ}_{n} )}^{2} + {( {\sum }_{n = 1}^{N} {C}_{1 , n} ( p ) sin {ψ}_{n} )}^{2}}$$
where I₁ is the first intensity image, I₁(p) is the intensity value of a pixel p in the first intensity image, C₁ is the first set of correlation images, C_{1,n}(p) is the value for pixel p in the n^{th} correlation image in C₁, N is a number of correlation images in C₁, and ψₙ is a phase shift of the demodulation function used to generate the n^{th} correlation image, such that the first intensity image is blurred based on motion in the scene; and
determine the set of depth estimates for the scene according to the following expression:
$${Z}_{1} ( p ) = \frac{c}{4 π {f}_{1}} {tan}^{- 1} ( \frac{{\sum }_{n = 1}^{N} {C}_{1 , n} ( {p}^{′} ) sin {ψ}_{n}}{{\sum }_{n = 1}^{N} {C}_{1 , n} ( {p}^{′} ) cos {ψ}_{n}} )$$
where Z₁ is the set of depth estimates for the scene based on C₁, Z₁(p) is the depth estimate of pixel p in the first intensity image, C_{1,n}(p′) is the value for a pixel p′ in the n^{th} correlation image in C₁ in the set of corresponding pixels that includes C_{1,1}(p), and f₁ is a fundamental frequency of the first signal.

14. A method for estimating depths of a dynamic scene, the method comprising:
causing a light source to emit modulated light toward the scene, with modulation based on a first signal from a signal generator configured to output at least the first signal corresponding to a modulation function;
causing an image sensor to generate, during a first period of time, a first set of correlation images comprising a first plurality of correlation images,
wherein the image sensor comprises a plurality of pixels, and
wherein each correlation image of the first plurality of correlation images comprises a plurality of pixel values, and each pixel value of the plurality of pixel values is based on a correlation between modulated light received from a portion of the scene at that pixel and a demodulation function of a plurality of demodulation functions;
generating a first intensity image based on the first set of correlation images,
wherein the first intensity image comprises a first plurality of intensity values;
causing the image sensor to generate, during a second period of time, a second set of correlation images comprising a second plurality of correlation images;
generating a second intensity image based on the second set of correlation images,
wherein the second intensity image comprises a second plurality of intensity values;
calculating a first model of the first intensity image based on the first plurality of intensity values;
calculating a second model of the second intensity image based on the second plurality of intensity values;
determining estimated lateral motion in the scene between the first period of time and the second period of time based on the first model and the second model; and
determining a set of depth estimates for the scene based on the first plurality of correlation images and the estimated lateral motion in the scene,
wherein the set of depth estimates comprises, for each of the plurality of pixels, a depth estimate for a corresponding portion of the scene during the first period of time.

15. The method of claim 14, further comprising:
generating a refined intensity image based on the first plurality of correlation images and the estimated lateral motion in the scene,
wherein a signal-to-noise ratio of the refined intensity image is higher than a signal-to-noise ratio of the intensity image.

16. The method of claim 13, further comprising:
determining a second set of depth estimates for the scene based on the second plurality of correlation images and the estimated lateral motion in the scene,
wherein the second set of depth estimates comprises, for each of the plurality of pixels, a depth estimate for a corresponding portion of the scene during the second period of time; and
determining an estimate of axial motion for at least a portion of the scene based on the first set of depth estimates, the second set of depth estimates, and the estimated lateral motion in the scene.

17. A system for estimating depths of a dynamic scene using indirect time-of-flight (I-ToF), the system comprising:
one or more processors configured to:
receive a first set of correlation images generated by an I-ToF camera during a first period of time;
receive a second set of correlation images generated by the I-ToF camera during a second period of time;
generate a first blurred intensity image using the first set of correlation images;
generate a second blurred intensity image using the second set of correlation images;
determine estimated lateral motion in the scene between the first period of time and the second period of time based on a distribution of intensity values in the first blurred image and a distribution of intensity values in the second blurred image;
determine a first depth map for the scene based on the first set of correlation images and the estimated lateral motion in the scene; and
determine a second depth map for the scene based on the second set of correlation images and the estimated lateral motion in the scene.

18. The system of claim 17, further comprising the I-ToF camera, wherein the I-ToF camera comprises a first processor of the one or more processors.

19. The system of claim 17, wherein the one or more processors are further configured to:
generate a first refined intensity image using the first set of correlation images and the estimated lateral motion in the scene; and
generate a second refined intensity image using the second set of correlation images and the estimated lateral motion in the scene.

20. The system of claim 17, wherein the one or more processors are further configured to:
determine estimated axial motion in the scene between the first period of time and the second period of time based on differences between depth values in the first depth map and depth values in the second depth map identified using the estimated lateral motion in the scene.
